(19) United States
(12) Patent Application Publication
(10) Pub. No.: US 2025/0340743 A1
(43) Pub. Date: Nov. 6, 2025

(54) Polyetheramine-Based Multifunctional Booster

(71) Applicant: Troy Technology II, Inc., Florham Park, NJ (US)

(72) Inventors: Jake Jacobs, Florham Park, NJ (US); Meihua Yang, Florham Park, NJ (US); Gladys Michelle Dimitriadis, Florham Park, NJ (US); Wolfgang Lindner, Florham Park, NJ (US); Chun Liu, Sugar Hill, GA (US)

(21) Appl. No.: 18/873,424

(22) PCT Filed: Jun. 9, 2023
(86) PCT No.: PCT/US2023/024944

§ 371 Date: Dec. 10, 2024

Related U.S. Application Data
(60) Provisional application No. 63/351,025, filed on Jun. 10, 2022.
(60) Provisional application No. 63/405,544, filed on Sep. 12, 2022.

(51) Int. Cl. C09D 5/14; C08K 5/098; C08K 5/17; C08K 5/5415; C09D 7/63; C09D 7/65

(52) U.S. Cl. CPC C09D 5/14; C08K 5/098; C08K 5/17; C08K 5/5415; C09D 7/63; C09D 7/65

(57) ABSTRACT

The present disclosure is generally directed to a multifunctional booster composition comprising a polyetheramine and at least one additive comprising an inorganic metal compound, a silicate, a pyrithione salt, or an organic amine, wherein R1 is H or C1 to C9 alkyl, each of R2, R3, and R4 is independently H or CH3, and each of x, y, and z is independently 1 to 10. According to the present disclosure, the weight ratio of the polyetheramine to the additive is from about 1:5 to 100:1.

### RELATED APPLICATIONS

The present application is based on and claims priority to U.S. Provisional Patent Application Ser. No. 63/351,025 filed on Jun. 10, 2022 and U.S. Provisional Patent Application Ser. No. 63/405,544 filed on Sep. 12, 2022, and, which are incorporated herein by reference.

### BACKGROUND

Preservation of water-based materials continues to be complicated by regulations that ban or restrict the use of certain active components. For the active components that continue to be widely used, some carry labeling implications at effective use levels. For this reason, methods of improving the activity of in-can preservatives at “label-free” levels is highly desired by the industry.

In part due to the regulatory and labeling implications of preservative incorporation, many coatings producers in the European Union, now regulated by the Biocidal Products Authority (BPR), are producing biocide-free paints. These biocide-free paints are produced by bringing the pH to ˜11 which is generally believed to limit the growth of microorganisms. However, while the paints are free from biocide, they are not free from issues. For example, high pH can be irritating, limits the use of many commonly used paint additives, and significant levels of alkaliphilic bacteria have been detected actively growing in the paints.

Typical usage levels of BIT in coatings are 200-500 ppm. Due to the weaknesses of BIT (e.g., efficacy against Pseudomonas), the active is usually combined with additional biocidal ingredients. However, regulators continue to restrict usage levels of the additional biocidal ingredients as well as BIT, forcing “remaining” ingredients like BIT to become preservation workhorses at low levels. The combination of single-active preservation at low use levels can lead to the development of tolerance to biocide in a plant setting and lead to major spoilage issues that are difficult to remediate in an industrial setting.

Beyond limitations set by regulators, even in regions where acceptable active substance use levels are broader and do not carry labeling implications, producers can struggle to achieve good preservation at reasonable cost-in-use.

For these reasons, there exists a strong need to provide a multifunctional booster to the industry that simultaneously improves the activity of active ingredients to improve the overall preservation quality or to allow for preservation at levels that can meet “label free” requirements in certain regions. Further, by the ingredient being multifunctional, there can be simultaneous savings and SKU-reduction on functions supplied by numerous other additives (e.g., dispersants, defoamers, rheology modifiers, surfactants, pH adjusters).

### SUMMARY

The present disclosure is generally directed to a multifunctional booster composition comprising a polyetheramine and at least one additive comprising an inorganic metal compound, a silicate, a pyrithione salt, and an organic amine, wherein R1 is H or C1 to C9 alkyl, each of R2, R3, and R4 is independently H or CH₃, and each of x, y, and z is independently 1 to 10. According to the present disclosure, the weight ratio of the polyetheramine to the additive is from about 1:5 to about 100:1.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 depicts kill curve of BIT and dispersion booster (“1737-35”) combinations against Pseudomonas aeruginosa (ATCC #10145) over 24 hours.

FIG. 2 depicts kill curve of BIT and solution booster (“1737-67”) combinations against Pseudomonas aeruginosa (ATCC #10145) over 24 hours.

FIG. 3 depicts kill curve of BIT and solution booster (“1737-72”) combinations against Pseudomonas aeruginosa (ATCC #10145) over 24 hours.

FIG. 4 displays L*, Delta-E values and Yellowness Index results over 8 weeks Architectural Semi-Gloss with and without Jeffamine T-403 or “1737-72.”

FIG. 5 depicts pH Readings on Laboratory Trials of Architectural Semi-Gloss paint over 8 weeks on the laboratory trials tested with and without Jeffamine T-403 or “1737-72.”

FIG. 6 charts fineness of grind, air content and opacity of Architectural Semi-gloss Paint with and without Jeffamine T-403 or “1737-72.”

FIG. 7 depicts KU Viscosity Profile of standard Architectural Semi-gloss Paint with and without Jeffamine T-403 or “1737-72.”

FIG. 8A depicts Lamp Black Color Analysis on on Architectural Paint with and without Jeffamine T-403 or “1737-72.”

FIG. 8B depicts Phthalo Blue Colorimetry Reading on Architectural Paint with and without Jeffamine T-403 or “1737-72.”

FIG. 8C depicts Red Oxide Colorimetry Reading on Architectural Paint with and without Jeffamine T-403 or “1737-72.”

FIG. 9 depicts Scrub Resistance Cycles to Failure Results for Architectural Semi-gloss Paint with and without Jeffamine T-403 or “1737-72.”

FIG. 10 depicts Practical Washability Test Results on films prepared from Semi-gloss Architectural Paint with and without Jeffamine T-403 or “1737-72.”

FIG. 11 charts Practical Washability Test Results on films prepared from Semi-gloss Architectural Paint with and without Jeffamine T-403 or “1737-72.”

FIG. 12 depicts Stain Resistance Test with L* and Delta E Values of films prepared from Architectural Paint with and without Jeffamine T-403 or “1737-72.”

FIG. 13 depicts Accelerated Weathering Exposure Results (Cycles UV: 8 hours at 60° C. Condensation: 4 hours at 50° C.) of films prepared from Architectural Paint with and without Jeffamine T-403 or “1737-72.”

FIG. 14 depicts In-can Appearance of Test Samples and Degree of Separation or Settling of Architectural Paint with and without Jeffamine T-403 or “1737-72.”

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to a multifunctional booster composition comprising a polyetheramine having the structure of Formula I:

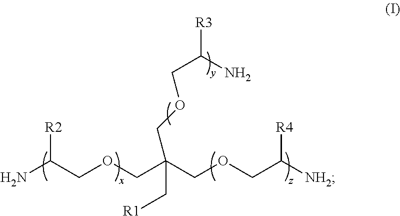

and
at least one additive comprising an inorganic metal compound, a silicate, a pyrithione salt, or an organic amine, wherein R1 is H or C₁ to C₉ alkyl, each of R2, R3, and R4 is independently H or CH₃, and each of x, y, and z is independently 1 to 10. According to the present disclosure, the weight ratio of the polyetheramine to the additive is from about 1:5 to about 100:1.

Surprisingly, the polyetheramine alone or in combination with additional components act as a multifunctional booster to simultaneously boost activity of in-can preservatives and to provide other benefits to coating properties (e.g., rheology, pH stabilization, color acceptance, or a combination thereof).

The degree of polymerization (x, y, and z) of Formula I is independently 1 to 10. The polymerization degrees x, y, and z can be the same or different in some instances. For instance, x may be one, y may be two, and z may be three. In another instance, z, y, and z may each be two. In one embodiment, the sum of polymerization (e.g., the total of x, y, and z values) is no less than 5, such as 6, 7, 8, 9, or 10. In one embodiment, the sum of x, y, and z values is no greater than 10.

The polyetheramine is a primary aliphatic polyamine. For instance, the polyetheramine may be polyoxypropylenetriamine or polyoxyprolyenetriamine. In one embodiment, the polyetheramine of Formula I is Jeffamine® T403 polyetheramine (Huntsman Corp., Houston, Texas). The multifunctional booster of the present disclosure may comprise one or more polyetheramine. The polyetheramine may be present in the composition in an amount from about 20% by weight to about 80% by weight, such as from about 25% by weight to about 75% by weight, such as from about 35% by weight to about 60% by weight, such as from about 40% by weight to about 55% by weight, or any range therebetween, based on the weight of the composition.

Further, the polyetheramine of Formula I of the multifunctional booster composition disclosed herein is combined with at least one additive or booster including an inorganic metal compound, a silicate, a pyrithione salt, an organic amine, or a combination thereof. In one embodiment, the polyetheramine to additive has a weight ratio of from about 1:500 to about 50:1, such as from about 1:400 to about 40:1, such as from about 1:250 to about 25:1, such as from about 1:100 to about 20:1, such as from about 1:50 to about 15:1, such as from about 1:20 to about 10:1, or any range therebetween.

In one embodiment, the multifunctional booster composition disclosed herein includes an inorganic metal compound. For instance, the inorganic metal compound may include, but is not limited to, an inorganic zinc compound, an inorganic magnesium compound, an inorganic copper compound, an inorganic lithium compound, or a combination thereof. In one embodiment, the inorganic metal compound is an inorganic zinc compound, such as one or more of zinc oxide (at times referred to herein as “ZnO”), zinc nitrate, zinc chloride, and zinc acetate. Preferably, the zinc oxide comprises a zinc oxide particle size less than 50 microns. The inorganic zinc compound is present in the multifunctional booster composition at a concentration from about 0.2% by weight to about 5% by weight, 0.5% by weight to 3.5% by weight, 1% by weight to 2.5% by weight, 1.5% by weight to 2% by weight, or any range therebetween, based on the weight of the composition. For instance, the weight ratio of polyetheramine to zinc acetate can be within the range of from 50:1 to 1:5, limits included. In some embodiments, the weight ratio of polyetheramine to zinc acetate in the preservative compositions disclosed herein is 20:1 to 1:20, 15:1 to 1:15, 10:1 to 1:10, 5:1 to 1:5, or 4:1 to 1:4. In another embodiment, the weight ratio of polyetheramine to zinc acetate is 2:1.

The polyetheramine of Formula I in combination with an inorganic zinc compound is capable of acting as a multifunctional booster to simultaneously boost activity of in-can preservatives and to provide other benefits to coating properties (e.g., rheology, pH stabilization, color acceptance, or a combination thereof). at a concentration from about 0.075% by weight to about 1% by weight, such as from about 0.1% by weight to about 0.75% by weight, such as from about 0.15% by weight to about 0.45% by weight, or any range therebetween.

In one embodiment, the inorganic metal compound is an inorganic magnesium compound, such as magnesium oxide. For instance, the magnesium compound may be present in the composition at a concentration from about 5% by weight to about 20% by weight, such as from about 7.5% by weight to about 15% by weight, such as from about 10% by weight to about 13.5% by weight, or any range therebetween.

In one embodiment, the inorganic metal compound is an inorganic copper compound, such as copper salts. For instance, copper salt may include copper sulfate, copper nitrate, copper carbonate, copper carbonate hydroxide, copper oxide, copper oxychloride, copper hydroxide, copper acetylacetonate, copper pyrrolidone carboxylic acid (PCA), copper PCA methylsilanol, copper acetyl tyrosinate methylsilanol, copper acetylmethionate, copper aminoacetylamidoimidazolyl propionate, copper picolinate, copper tripeptide-1, bis (tripeptide-1) copper acetate, copper ascorbyl phosphate succinoyl tripeptide-34, copper pyrithione, sodium calcium copper phosphate, copper pyridoxal-5-phosphate, sodium copper chlorophyllin, copper chlorophyll, disodium EDTA copper, or a combination thereof. In one embodiment, the copper salt may include one or more of copper sulfate, copper nitrate, copper carbonate, copper oxide, and copper acetylacetonate.

In one embodiment, the inorganic metal compound is an inorganic lithium compound, such as lithium salts. For instance, lithium salts may include lithium carbonate, lithium acetate, lithium fluoride, lithium sulfate, lithium nitrate, lithium tetraborate, lithium metaborate, lithium pyrophosphate, lithium tripolyphosphate, lithium orthosilicate, lithium metasilicate, or a combination thereof.

In another embodiment, the multifunctional booster composition disclosed herein may include a silicate. Silicates may include, but are not limited to, silicas such as modified silicas and fumed silicas. In one embodiment, the silicate may be one or both of potassium methylsilicionate and sodium metasilicate (e.g., sodium metasilicate pentahydrate). Commercial examples include Silres 168 (Wacker), Tyson WR50 (Tyson, Singapore), and Xiameter OFS0777 (Corning). The silicate is present in the multifunctional booster composition in an about from about 0.5% by weight to about 15% by weight, such as from about 1% by weight to about 10% by weight, such as from about 2.5% by weight to about 7.5% by weight, or any range therebetween, based on the weight of the composition.

In one embodiment, the multifunctional booster composition disclosed herein may include one or more pyrithione salts. For instance, such pyrithione salts may include zinc pyrithione, sodium pyrithione, potassium pyrithione, lithium pyrithione, ammonium pyrithione, calcium pyrithione, magnesium pyrithione, an organic amine pyrithione, barium pyrithione, strontium pyrithione, copper pyrithione, cadmium pyrithione, or a combination thereof. In one embodiment, the multifunctional booster composition disclosed herein does not contain a pyrithione salt. In another embodiment, the multifunctional booster composition may comprise one or both of zinc pyrithione and sodium pyrithione. The pyrithione salt is present in the multifunctional booster composition in an about from about 0.005% by weight to about 1% by weight, such as from about 0.015% by weight to about 0.5% by weight, such as from about 0.025% by weight to about 0.25% by weight, or any range therebetween, based on the weight of the composition. For instance, the pyrithione salt can be present in the multifunctional booster composition from about 5 ppm to about 500 ppm, such as from about 50 ppm to about 300 ppm, such as from about 100 ppm to about 250 ppm, or any range therebetween.

In one embodiment, the multifunctional booster composition disclosed herein may include an organic amine, such as a pH adjusting agent. The organic amine may include, but are not limited to, 2-amino-2-methyl-1-propanol (“AMP95”), ethanolamine, 1-amino-2-propanol, 3-amino-1-propanol, 2-(methylamino) ethanol, 2-(ethylamino) ethanol, 2 (propylamino) ethanol, 2 (isopropylamino) ethanol, diethanolamine, triethanolamine, diisopropanolamine, triisopropanolamine, 2-amino-2-ethyl-1,3-propanediol (also called AEPD), 2 (2-aminoethoxy) ethanol (also called diglycol amine), N-methyldiethanolamine, N,N-dimethylethanolamine, N,N-diethylethanolamine, N,N-dibutylaminoethanol, N,N dimethylamino-2-propanol, etc. The organic amines may be used individually or in any combination. In one embodiment, the organic amine may comprise 2-amino-2-methyl-1-propanol (“AMP95”). For instance, AMP95 is present in the composition at a concentration from about 25% by weight to about 75% by weight, such as from about 40% by weight to about 65% by weight, such as from about 50% by weight to about 60% by weight, or any range therebetween.

Advantageously, the water-based industrial material comprising a multifunctional booster composition disclosed herein does not contain or is “essentially free” of a biocidal agent. In one embodiment, the multifunctional booster composition disclosed herein does not contain a biocidal agent, such as isothiazolin-3-one. For instance, the water-based industrial material is “essentially free” of 1,2-benzisothiazolin-3-one (“BIT”), N-(n-butyl)-1,2-benzisothiazolin-3-one, 4,5-dichloro-2-n-octyl-4-isothiazolin-3-one (“DCOIT”), 2-methyl-4-isothiazolin-3-one, 5-chloro-2-methyl-4-isothiazolin-3-one, 2-methyl-4-isothiazolin-3-one, 5-chloro-2-methyl-2H-isothiazol-3-one/2-methyl-2H-isothiazol-3-one (“CMIT/MIT”), or a combination thereof. However, if desired, the water-based industrial material according to example aspects of the present disclosure may include additional non-isothiazolinone biocidal agent. For example, the water-based industrial material may contain include one or more non-isothiazolinone biocidal agents, such as methylbenzimidazole-2-yl carbamate (“BCM”), IPBC, 3-(3,4-dichlorphenyl)-1,1-dimethylurea (“Diuron”), and/or 2-bromo-2-nitropropane-1,3-diol (“Bronopol”). Supplemental algaecides that can be used include, but are not limited to, 2-tert-Butylamino-4-ethylamino-6-methylthio-1,3,5-triazin (“Terbutryn”) and 3-(4-isopropylphenyl)-1,1-dimethylurea (“Isoproturon”).

Other examples of non-isothiazolinone biocidal agents are tetra-alkylphosphonium halogenides, guanidine derivatives, imidazole containing compounds such as 4-[1-(2,3-dimethylphenyl)ethyl]-1H-imidazole [medetomidine] and derivatives, macrocyclic lactones including avermectins and derivatives thereof such as ivermectin, or spinosyns and derivatives thereof such as spinosad, or enzymes such as oxidase, or proteolytically, hemicellulolytically, cellulolytically, lipolytically or amylolytically active enzymes.

It will be advantageous for any biocide present in the multifunctional booster composition disclosed herein to be in the form of relatively fine particles, for example, particles having a particle size of from 5 to 75 microns. The desired particle size may be attained with conventional techniques such as grinding, milling, sieving and the like. The biocidal agent is present in the multifunctional booster composition in an about from about 0.001% by weight to about 1% by weight, such as from about 0.015% by weight to about 0.85% by weight, such as from about 0.25% by weight to about 0.5% by weight, or any range therebetween, based on the weight of the composition. For instance, the biocidal agent can be present in the multifunctional booster composition from about 50 ppm to about 1500 ppm, such as about 100 ppm to about 1000 ppm, such as from about 250 ppm to about 750 ppm, such as from about 350 ppm to about 500 ppm, or any range therebetween.

Optionally, the multifunctional booster compositions of the present disclosure may utilize one or more surfactants. The surfactants function as emulsifiers and help to keep the water-insoluble components of the formulation in the form of a stable dispersion (emulsion) of small particles suspended in an aqueous phase.

Suitable types of nonionic surfactants include, but are not limited to, polyoxyalkylene glycol alkyl ethers (e.g., polyoxyethylene glycol alkyl ethers, polyoxypropylene alkyl ethers, polyoxyethylene/propylene alkyl ethers), glucoside alkyl ethers, polyoxyalkylene glycol alkylphenol ethers (e.g., polyoxyethylene glycol alkylphenol ethers, polyoxypropylene glycol alkylphenol ethers, polyoxyethylene/propylene glycol alkylphenol ethers), glycerol alkyl esters, polyoxyalkylene glycol sorbitan alkyl esters (e.g., polyoxyethylene glycol sorbitan alkyl esters), sorbitan alkyl esters, cocamide MEA, cocamide DEA, block copolymers of polyethylene glycol and polypropylene glycol (poloxamers), polyalkoxylated tallow amines, alkoxylated fatty acids and the like and combinations thereof.

Particular nonionic surfactants include alkoxylated aliphatic mono-alcohols and alkoxylated aromatic mono-alcohols. Such surfactants are typically prepared by reacting one or more alkylene oxides (e.g., ethylene oxide, propylene oxide, mixtures of ethylene oxide and propylene oxide) with one or more mono-alcohols (e.g., aliphatic alcohols, which may be for example linear or branched, primary or secondary, or aromatic alcohols, such as phenols, including alkyl- and aralkyl-substituted phenols). The number of moles of alkylene oxide reacted per mole of the mono-alcohol may be varied as may be desired, but typically is from about 2 to about 50 on average. If more than one type of alkylene oxide is used, the alkylene oxides may be reacted as a mixture (to provide a polyoxyalkylene segment having a random copolymer structure) or sequentially (to provide a polyoxyalkylene segment having a block copolymer structure).

Another type of nonionic surfactant for use in the present disclosure is an alkoxylated aliphatic mono-alcohol which is an ethoxylated C₁₀-C₁₈ aliphatic alcohol (in particular, a linear primary C₁₂-C₁₆ aliphatic alcohol (or mixture of such alcohols) which has been reacted with about 6 to about 15 moles of ethylene oxide per mole of aliphatic alcohol to provide an alkoxylated alcohol containing an average of about 6 to about 15 oxyethylene repeating units per molecule). For example, the alkoxylated aliphatic mono-alcohol may be an ethoxylated C₁₂-C₁₆ linear aliphatic alcohol containing an average of about 8 to about 12 ethylene oxide units per molecule. In particular, ethoxylated tridecanol containing an average of about 10 ethylene oxide units is suitable for use in the present disclosure.

Another type of nonionic surfactant for use in the present disclosure is an alkoxylated C₂-C₈ aliphatic alcohol containing both ethylene oxide and propylene oxide units. The C₂-C₈ aliphatic alcohol may be n-butanol, for example. The ethylene oxide and propylene units may be arranged in a block manner (e.g., the surfactant may contain a polyoxyethylene block and a polyoxypropylene block). Also suitable for use as nonionic surfactants are alkoxylated phenols, in particular ethoxylated phenols wherein the phenol may be substituted with one or more alkyl groups (in particular, long chain alkyl groups such as nonyl or dodecyl groups or aralkyl groups, such as in tristyrylphenol).

Suitable anionic surfactants include, but are not limited to, surfactants containing anionic functional groups at their head, such as sulfate groups, sulfonate groups, phosphate groups, and carboxylate groups. The cationic counterion to the anionic functional group may be, for example, an alkali metal (e.g., Na, K) or an amine (ammonium) cation such as a quaternary ammonium. Useful types of anionic surfactants in the present disclosure include, but are not limited to, alkyl sulfates, alkyl ether sulfates, sulfated alkanolamides, glyceride sulfates, alkyl aryl sulfonates (including straight-chain alkylbenzenesulfonates, branched alkylbenzenesulfonates, alkylnaphthalene-sulfonates), alpha olefin sulfonates, lignosulfonates, sulfo-carboxylic compounds (e.g., sodium lauryl sulfoacetate, sulfosuccinates (including dialkylsulfosuccinates), sulfosuccinamates, organo phosphored surfactants, sacrosides, hydroxyalkane-sulfonates, alkanesulfonates, alkylphenoxy polyoxyethylene propyl sulfonates, salts of polyoxyethylene alkylsulfophenyl ethers, sodium N-methyl-N-oleyltaurates, monoamide disodium N-alkylsulfosuccinates, petroleum sulfonates, sulfated castor oil, sulfated tallow oil, salts of sulfuric esters of aliphatic alkylesters, salts of alkylsulfuric esters, salts of alkylsulfuric esters, sulfuric esters of polyoxyethylenealkylethers, salts of sulfuric esters of aliphatic monoglycerides, sodium salt of the monosulfated monoglyceride of hydrogenated coconut oil fatty acids, salts of sulfuric esters of polyoxyethylene alkylphenylethers, salts of alkylphosphoric esters, salts of phosphoric esters of polyoxyethylenealkylethers, salts of phosphoric esters of polyoxyethylenealkylphenylethers, partially saponified compounds of styrene-maleic anhydride copolymers, partially saponified compounds of olefin-maleic anhydride copolymers, naphthalenesulfonate-formalin condensates, higher alkyl sulfoacetates, and higher fatty acid esters of 1,2-dihydroxy propane sulfonate and combinations thereof. Particular among these anionic surfactants are sulfonate surfactants, in particular salts of alkyl aryl sulfonates, especially salts of C₈-C₁₈ alkyl benzene sulfonates such as salts of dodecylbenzene sulfonate, and combinations thereof.

A total amount of surfactant is used that is effective, in combination with the any thickeners and/or suspending agent that may be present in the composition, to provide a physically stable dispersion. The amount of surfactant needed to achieve a physically stable dispersion will depend on a number of factors, including, for instance, the types and amounts of polyetheramines and thickeners/suspending agents present and well as the types of surfactants utilized. Typically, however, an amount of surfactant is used which is sufficient to provide a weight ratio of polyetheramine:surfactant within the range of from about 5:1 to about 50:1 or from about 6:1 to about 20:1.

Further, certain surfactants and combinations of surfactants also have well-known activities disrupting membranes. This activity is general to several cationic surfactants, but is also true of certain non-ionic and ionic surfactants.

If desired, the multifunctional booster compositions of the present disclosure may include one or more substances capable of functioning as thickener or suspending agents to render the compositions physically stable. In particular, the types and amounts of thickeners and/or suspending agents are selected such that at 25° C. the resulting multifunctional booster composition has a viscosity of at least 300 cps. In other embodiments, the viscosity of the multifunctional booster composition at 25° C. is at least 400 cps or at least 500 cps. Generally, it will be desirable for the viscosity of the multifunctional booster composition to not be increased to the point where it becomes difficult to transfer or handle the multifunctional booster composition by means of pumping. Viscosity is measured using a Brookfield viscometer (spindle #5, 100 rpm).

Suitable thickeners/suspending agents include, without limitation, clays (including natural clays and organo-modified clays), silicates (e.g., silicas such as modified silicas and fumed silicas), polysaccharides (e.g., gums such as xanthan gum, cellulosic polymers), polyacrylates, and the like and combinations thereof.

One or more other components, in addition to those mentioned above, may additionally be present in the multifunctional booster compositions of the present disclosure. In certain embodiments, however, the multifunctional booster composition consists essentially of or consists of only the aforementioned components, except that one or more defoamers may optionally be present in such embodiments.

Additional optional components include, but are not limited to, dispersants, defoamers (antifoams, e.g., silicone-based defoamers, mineral oil-based defoamers, hydrophobic silica-based defoamers), sequestering/chelating agents, fillers, coloring agents, antifreezing agents, corrosion inhibitors (anti-corrosion additives), ultraviolet light stabilizers, antioxidants, solvents, co-solvents, scale inhibitors, and the like.

Multifunctional booster compositions in accordance with the present disclosure may be prepared by adaptation of any of the techniques known in the art for creating dispersions of water-insoluble substances in water using surfactants (emulsifiers), thickeners, suspending agents, and combinations of these ingredients. For example, a suitably sized mixing vessel may be charged with water, followed by the surfactants desired to be included in the multifunctional booster composition. While agitating the surfactant/water mixture, the polyetheramine and a portion of the thickeners/suspending agents are added. Mixing at high speed and/or high shear may be continued until a homogeneous emulsion having the desired particle size (typically 5 to 75 microns) is obtained. The mixture may be heated to a temperature somewhat above room temperature during this step. The remaining thickeners/suspending agents may then be added and the mixture agitated until homogeneous once again. The mixture may be cooled to room temperature prior to the final addition of thickeners/suspending agents. The multifunctional booster composition may then be transferred by pumping or other means to one or more suitable storage containers such as tanks, drums or totes.

The multifunctional booster compositions of the present disclosure are useful for imparting resistance to microorganism growth, including bacterial, fungal and algae growth, in a wide variety of working compositions, in particular water-based products. As the multifunctional booster compositions are typically prepared containing relatively high concentrations of active ingredients (i.e., biocides), they generally find use as concentrates which are combined, in relatively small quantities, with one or more other ingredients in order to formulate a final product suitable for use for its intended purpose.

The working compositions of the disclosure comprise a polyetheramine and an additional additive or booster disclosed herein. In one embodiment, the multifunctional booster composition comprises a polyetheramine and an inorganic zinc compound.

The multifunctional booster composition disclosed herein can effectively enhance the performance of in-container preservatives. “In-container preservative performance” refers to enhancing various properties, including rheology, pH stabilization, color acceptance, and preservative boosting of the industrial material. For instance, incorporating the multifunctional booster or compositions disclosed herein at a concentration of from about 0.2% by weight to about 0.4% by weight into a no volatile organic compounds (VOC) acrylic semi-gloss architectural coating formulation boosts viscosity stability over time.

In various aspects, the working composition is a paint or coating composition, wherein other ingredients may include one or more pigments, polymeric resin binders or fillers (e.g., latex resins), and a carrier vehicle such as water. Particular polymeric resins may include acrylate, butadiene, PVA, EVA, styrene, or vinyl acetate polymers. In one embodiment of the disclosure, the multifunctional booster composition is dosed into a coating composition, in particular a water-based coating composition such as a latex paint, in an amount from about 0.02% by weight to about 4% by weight of the coating composition.

In another example aspect, the water-based industrial material of the disclosure may be a joint sealing compound. Joint sealing compound (also known as wallboard joint compound, drywall joint compound, or wallboard mud) may be used to attach tape to wallboard (also known as drywall, plasterboard or sheetrock) in order to cover the tape and conceal imperfections in the surface of the wallboard. A typical wallboard joint compound may contain substantial or larger proportions of gypsum or limestone and water and relatively smaller proportions of stone, clay, and a polymer.

Another example aspect of the disclosure includes a method for inhibiting or preventing the growth of microorganisms in an industry material that may be subject or susceptible to contamination by bacteria, fungi, yeasts, algae, and slimes. For instance, the method can include incorporating into or onto the industrial material a multifunctional booster according to example aspects of the present disclosure in an amount which is effective to adversely affect the growth of microorganisms.

The multifunctional booster disclosed herein may be incorporated into an architectural paint. In one example implementation, the architectural paint includes a solvent (e.g., water), a latex binder (e.g., a polymer including one or more acrylate, vinyl acetate, vinyl chloride, and/or styrene butadiene monomers), and the multifunctional booster. Optionally, the architectural paint can further include a dispersant and/or surfactant to improve distribution of the latex binder throughout the architectural paint. In this manner, the dispersant and/or surfactant can be used to produce a more homogenous mixture that can provide a more even coating of the architectural paint. Optionally, the architectural paint can include a thickening agent to adjust the viscosity of the architectural paint to improve adhesion of the wet paint to an applicator (e.g., a brush or roller). Optionally, the architectural paint can include one or more pigments (e.g., TiO2) for providing a color to the architectural paint. Optionally, the architectural paint can include a cosolvent (e.g., ethylene glycol) that can improve solubility of components of the architectural paint. An example aspect of implementations according to the present disclosure can include a no or low volatile organic compounds (VOCs) content. High VOCs are recognized as environmental hazards as well as demonstrating personal hazards to painters who work in confined and/or unventilated spaces. In these spaces, VOCs can collect in the air which may cause breathing issues for painters and possible health concerns. Many known paint additives that are used to modify the paint open time are known high VOCs which has posed challenges. Poor open time performance can require increased working time to correct mistakes, such as streaking that are inherent to the paint composition. Thus, improving open time while also mitigating VOC content can provide a great advantage in the cost and efficiency of paint projects as well as the health of painters.

Another aspect of example implementations can include a type of latex binder. The latex binder can include various polymers suitable for architectural paints such as an acrylate (e.g., polymethylmethacrylate), that can be formed as a homopolymer or co-polymer. For example, a co-polymer can include incorporation of another monomer (e.g., butadiene styrene). In some implementations, the acrylate can be modified to include one or more nitrile groups. Thus, latex binders can include various acrylates, acrylate butadiene styrene copolymers, and acrylonitrile butadiene styrene copolymers. Additionally, these latex binders are provided for example purposes, and additional latex binders may be used alone or in combination with implementations of the disclosure.

As an example for illustration, an implementation of the present disclosure can include an architectural paint including a latex binder with an acrylate. The acrylate can include a polymer or copolymer that includes one or more acrylate monomers. Example aspects of the acrylate polymer or copolymer can include a mass fraction of an acrylate monomer. For instance, the acrylate can include a copolymer that includes an acrylate monomer (e.g., methyl methacrylate) and a second monomer (e.g., butadiene styrene). The mass fraction of the acrylate monomer to the total weight of the copolymer can define the mass fraction. In some acrylates the mass fraction of acrylate monomer to the total weight of the copolymer can be no less than about twenty (20) wt % and no greater than about one hundred (100) wt % such as no less than about thirty (30) wt % and no greater than about eighty (80) wt %, no less than about forty (40) wt % and no greater than about seventy (70) wt %, or no less than about forty five (45) wt % and no greater than about sixty (60) wt % (e.g., one hundred (100) wt %, ninety five (95) wt %, ninety (90) wt %, eighty five (85) wt %, eighty (80) wt %, seventy five (75) wt %, seventy (70) wt %, sixty five (65) wt %, sixty (60) wt %, fifty five (55) wt %, or fifty (50) wt %). In particular, certain implementations can include an acrylate having a mass fraction of acrylate monomer to the total weight of acrylate greater than fifty (50) wt %.

Example implementations formulated according to the present disclosure may provide additional benefits for formulating low VOC architectural paints. In particular, example implementations may include a solvent that can be considered low or no VOC. For instance, water is not an organic compound and so is preferably incorporated in architectural paints of the present disclosure. In addition to water, a co-solvent can be included to improve solubility of components of the architectural paint (e.g., the multifunctional booster, surfactants, pigments, etc.). Example co-solvents may be VOC exempt (e.g., acetone, AMP-95, dimethyl carbonate, methyl acetate, parachlorobenzotrifluoride, tert-butyl acetate, and propylene carbonate) or be included in lower concentrations (e.g., lower weight percentages) to limit the VOC concentration of the architectural paint.

For instance, certain implementations of the present disclosure can include architectural paints having a VOC content of less than one thousandth of a percent (<0.001%) based on the total weight of the architectural paint. VOC content can be determined using various methods, preferably example implementations can include specific VOC content determined according to EPA Method 24 for surface coatings.

Alternative methods for determining VOC content may also be used to determine VOC content in some example implementations. For instance, ASTM D6886-14 does not specifically define what constitutes a VOC ingredient based on chemical properties, but rather, implies that any components that produce a peak in a gas chromatogram are considered VOC (exempt or non-exempt). Additionally, IOS 11890-2 can be used to determine VOC content based on a pre-defined boiling point limit. As an example, if the term “VOC” is being used for compounds whose boiling points are below the boiling point limit, a marker compound of known purity and with a boiling point (BP) within +3° C. of the defined maximum is used. So, if the EU definition for VOC is being employed (i.e., any compound with a boiling point below 250° C. is classified as VOC), tetradecane (with a BP of 252.6° C.) or a similar boiling point non-polar compound can be used as a marker compound for non-polar systems, while diethyl adipate (with a BP of 251° C.) can be used for polar systems,

Example implementations in accordance with the present disclosure may include a VOC content, as determined using one of the methods disclosed herein (e.g., EPA Method 24), of no less than one hundred thousandth of a percent (0.00001%) and no greater than one thousandths of a percent (0.001%), such as a VOC content no less than five hundred thousandths of a percent (0.00005%) and no greater than eight ten thousandths of a percent (0.0008%), or no less than on ten thousandth of a percent (0.0001%) and no greater than five ten thousandths of a percent (0.0005%). In some implementations, the VOC content can be substantially zero, for example including a substantially undetectable amount of VOC based on the analytical tool used to determine VOC content (e.g., a gas chromatograph).

For example implementations, the multifunctional booster can be present in the architectural paint in an effective amount to produce reduced streaking, even in environments that have low humidity. For instance, the multifunctional booster can be present at a concentration of no less than about a tenth of a percent (0.1%) and no greater than about five percent (5%) based the weight of the multifunctional booster to the total weight of the architectural paint, such as no less than about one half of a percent (0.5%) and no greater than about four and one half percent (4.5%), no less than about one percent (1.0%) and no greater than about four percent (4.0%), no less than about one and two tenths of a percent (1.2%) and no greater than about three and one half percent (3.5%), and no less than about two percent (2%) and no greater than about three percent (3%).

Another aspect of some implementations according to the present disclosure can include a solids content no less than five percent (5%) and no greater than seventy percent (70%), such as no less than eight percent (8%) and no greater than fifty percent (50%) or no less than ten percent (10%) and no greater than thirty percent (30%) [e.g., twelve percent (12%), fourteen percent (14%), fifteen percent (15%), sixteen percent (16%), or eighteen percent (18%)] based on the total weight of the latex binder.

Aspects of some implementations of the present disclosure the water-based industrial material can include a weight ratio of the multifunctional booster to the latex binder. Advantageously, the weight ratio of the multifunctional booster to the latex binder is no greater than 1:999 and no less than 1:9 such as no greater than 1:900 and no less than 1:9, no greater than 1:800 and no less than 1:9, no greater than 1:800 and no less than 1:90, or no greater than 1:800 and no less than 1:200 (e.g., 1:900, 1:800: 1:700 1:600, 1:500, 1:400, 1:300, 1:200, or 1:100).

As used herein, the weight ratio of the multifunctional booster to the latex binder should be understood on the basis of the multifunctional booster. As such, no greater than 1:999 should be read as for every one (1) weight unit of the multifunctional booster, there is no greater than nine-hundred and ninety-nine (999) weight units of the latex binder. As another example for illustration, no less than 1:9 should be read as for every one (1) weight unit of the multifunctional booster, there is no less than nine (9) weight units of the latex binder.

One example aspect of certain implementations can include an increase in open time resulting from the addition of the multifunctional booster to the architectural paint. To determine the increase in open time, a base paint having a composition that does not include the multifunctional booster can be modified to produce the architectural paint, by adding an effective amount of the multifunctional booster to the base paint. For some implementations, the addition of the effective amount of the multifunctional booster to the base paint can produce an increase in the open time determined for the architectural paint, relative to the base or reference paint alone, of no less than ten percent (10%), such as no less than twenty percent (20%), such as no less than thirty percent (30%), such as no less than forty percent (40%), such as no less than fifty percent (50%), such as no less than sixty percent (60%), such as no less than seventy-five percent (75%). Open time can be determined using a variety of methods, preferably implementations according to the present disclosure can determine open time according to OTA test ASTM D7488-11 “Standard Test Method for Open Time of Latex Paints”.

Alternatively or additionally, another example aspect of certain implementations can include an increase in scrub resistance resulting from the addition of the multifunctional booster to the paint composition. To determine the increase in scrub resistance, a testing method such as ASTM D2486 can be used to compare number of scrubs to failure and/or exposure of a substrate material after a number of scrubs. For instance, a first coating can be applied to the substrate material using a base paint and a second coating applied to the substrate material using an architectural paint, the architectural paint having been formulated by adding an effective amount of the multifunctional booster to the base paint. After applying an abrasive force (e.g., a scrub) to the coatings, the scrub resistance can be determined based at least in part on removal of the coating and/or exposure of the substrate material. In some implementations, addition of an effective amount of the multifunctional booster can produce an increase in scrub resistance (relative to the base paint) of no less than three hundred percent (300%) and no greater than one thousand percent (1000%), such as no less than five hundred percent (300%) and no greater than eight hundred (800%), e.g., about seven hundred and fifty percent (750%).

Alternatively or additionally, another example aspect of certain implementations can include an increase in stain resistance resulting from the addition of the multifunctional booster to the paint composition. To determine the increase in scrub resistance, a testing method such as ASTM D4828 can be used to compare number of stains to failure and/or exposure of a substrate material after a number of stain. For instance, a first coating can be applied to the substrate material using a base paint and a second coating applied to the substrate material using an architectural paint, the architectural paint having been formulated by adding an effective amount of the multifunctional booster to the base paint. After applying an abrasive force (e.g., a stain) to the coatings, the stain resistance can be determined based at least in part on removal of the coating and/or exposure of the substrate material. It is understood that the polyetheramine disclosed herein is not used as a chemical reactant as a primary mechanism of forming the coating.

Implementations of the present disclosure can also include methods for adjusting the open time of a base paint (e.g., an aqueous latex paint). The method may include forming an aqueous latex paint (e.g., a water-based acrylate) with a multifunctional booster having the structure of Formula I as described herein.

One example aspect forming the aqueous latex paint with the multifunctional booster can include homogenizing the aqueous latex paint while adding the multifunctional booster. Homogenizing can include various forms of mixing to facilitate incorporation of the multifunctional booster with the aqueous latex paint. For instance, homogenizing can include mixing at a specified rotation per minute (RPM) the aqueous latex paint, sonicating the aqueous latex paint at a specified frequency, and/or vortexing the aqueous latex paint. In this manner, the multifunctional booster can be incorporated throughout the aqueous latex paint to produce an architectural paint according to example implementations of the present disclosure. Thus, example implementations can further include methods for producing architectural paints, such as example architectural paints of the disclosure using example methods of the disclosure.

Another aspect of methods for producing an architectural paint can include determining a solids content for the base paint (e.g., the aqueous latex paint), and, based at least in part on the solids content, adding an amount of Compound I to the base paint. In particular, the solids content can determine a basis for including an effective amount of the multifunctional booster. For instance, the amount of latex binder can be determined based on the solids content and an effective amount of the multifunctional booster can be determined according to the ratio of the multifunctional booster to the latex binder disclosed in example implementations herein.

Certain methods for producing an architectural paint according to the present disclosure can further include modifying Formula I by adjusting the extent of polymerization (e.g., by selecting x, y, and/or z) to modify the open time of the aqueous latex paint.

The preceding description is exemplary in nature and is not intended to limit the scope, applicability or configuration of the disclosure in any way. Various changes to the described embodiments may be made in the function and arrangement of the elements described herein without departing from the scope of the disclosure.

Unless defined otherwise, all technical and scientific terms used herein have the same meaning as commonly understood by one of ordinary skill in the art to which this invention is related.

As used in this application and in the claims, the singular forms “a”, “an”, and “the” include the plural forms unless the context clearly dictates otherwise. Additionally, the term “includes” means “comprises”. The methods and compositions of the present disclosure, including components thereof, can comprise, consist of, or consist essentially of the essential elements and limitations of the embodiments described herein, as well as any additional or optional ingredients, components or limitations described herein or otherwise useful in biocidal compositions.

Unless otherwise indicated, all numbers expressing quantities of ingredients, properties such as molecular weight, percentages, and so forth, as used in the specification or claims are to be understood as being modified by the term “about”. Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” mean by weight as relative to another component or a percentage of the total weight in the composition.

The term “about” is intended to mean approximately, in the region of, roughly, or around. When the term “about” is used in conjunction with a numerical range, it modifies that range by extending the boundaries above and below the numerical values set forth. Unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

The term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

The phrase “effective amount” means an amount of a compound that promotes, improves, stimulates, or encourages a response to the particular condition or disorder or the particular symptom of the condition or disorder.

The terms “potentiator” and “adjuvant” as used herein refers to an additive that can affect the performance of an active compound when used in combination with the active compound but does not exhibit any biocidal activity itself and/or does not exhibit significant biocidal activity itself in the compositions of the invention at relevant use levels.

The term “biocidal agent” as used herein refers to any chemical compound that is intended to inhibit or kill organisms on a coating surface and/or that prevents or kills the growth of organisms “in-can” in an aqueous paint or coating prior to surface application.

The terms “antifouling paint” and “antifouling coating” are used interchangeably herein.

As used herein, the terms “first”, “second”, and “third” may be used interchangeably to distinguish one component from another and are not intended to signify location or importance of the individual components.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “D50” or “D50 particle size” refers to the volume median particle size, where 50% of the particles of the sample volume have a size below that range or value.

Analogously, as used herein, the term “D95” or “D95 particle size” refers to a value where 95% of the particles of the sample volume have a size below that range or value.

As used herein, the term “particle size” as used herein, unless specifically stated otherwise, refers to the median particle size D50. Particle size can be measured using a laser scattering particle size analyzer, such as a HORIBA LA 910 particle size analyzer.

The terms “median particle size” and “average particle size” and D50 are used herein interchangeably.

As used herein, the term “micronized” as used herein means a median particle size (D50) in the range of 0.01 to 25 microns.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Furthermore, certain aspects of the present disclosure may be better understood according to the following examples, which are intended to be non-limiting and exemplary in nature. Moreover, it will be understood that the compositions described in the examples may be substantially free of any substance not expressly described.

### EXAMPLES

### Example 1

The activity improvement of blends containing Jeffamine T403 in combination with other ingredients was determined. Potassium methyl siliconate (CAS #31795-24-1) and metal oxides were added and the effects against Pseudomonas bacteria in combination with traditional biocides was determined. The resulting dispersion type formulations were produced with 60% Jeffamine T403, 5% potassium methyl siliconate, and 3% of magnesium oxide (“1737-34”) or 3% zinc oxide (“1737-35”) with 32% inert materials including surfactants, emulsifiers, and solvents.

| | |
|---|---|
| Chemical Name | Percentage |

Ref- “1737-34”

| | |
|---|---|
| Jeffamine T403 | 60% |
| Magnesium Oxide | 3.0% |
| Huber 90 | 5.0% |
| Arlacel 83 | 1.5% |
| Ethylan NS 500LQ | 2.0% |
| Aerosil R972 | 2.0% |
| Potassium Methyl | 5.0% |
| Siliconate | |
| Methocil K100M | 0.05% |
| Water, distilled | 19.45% |
| Polypropylene | 2.0% |
| Glycol 200 | |

Ref- “1737-35”

| | |
|---|---|
| Jeffamine T403 | 60% |
| Zinc Oxide | 3.0% |
| Huber 90 | 5.0% |
| Arlacel 83 | 1.5% |
| Ethylan NS 500LQ | 2.0% |
| Aerosil R972 | 2.0% |
| Potassium Methyl | 5.0% |
| Siliconate | |
| Methocil K100M | 0.05% |
| Water, distilled | 19.45% |
| Polypropylene | 2.0% |
| Glycol 200 | |

### Commercial Product Compositions

| Product | Active Content | Carrier |
|---|---|---|
| Mergal K10N | 10% BIT | Water |
| Troyshield FSP40 | 40% Sodium Pyrithione | Water |
| Mergal CM1.5 | 1.5% CMIT/MIT | Water |
| AMP95 | 95% 2-amino-2-methyl- | — |
| | 1-propanol | |

To examine the preservative boosting potential of these dispersions, minimum inhibitory concentration (MIC) testing was performed. MICs were determined via microbroth dilution using the following specific test parameters:

| Format | 96-well plate | |
|---|---|---|
| Strength | ~1.0*10⁵ | CFU/mL |
| Standardization | OD₆₀₀ | |
| Incubation Temperature | 37° | C. |
| Incubation Time | 2 | days |

| | |
|---|---|
| Test Endpoint | No growth |
| | (via turbidity) |
| Test Media | MHB |

Necessary organism dilutions via OD₆₀₀ were calculated based on OD₆₀₀ of 1.0 being equivalent to 8×10⁸ CFU/mL. Biocide dilutions were performed in 2-fold increments for each assay.

The test results show that the magnesium oxide version “1737-34” achieves 2-fold lower MIC values against BIT and 4-fold lower MIC values with CMIT/MIT, but is clearly antagonistic with sodium pyrithione. The zinc oxide version “1737-35” achieves strong boosting of all three test biocides. Compared with Jeffamine T403 (Table 1), dispersion booster “1737-34” is weaker on a product basis, while dispersion booster “1737-35” is significantly stronger on the basis of % w/w, especially in combination with sodium pyrithione or CMIT/MIT (Table 2).

TABLE 1
MIC of three biocides alone and in combination with Jeffamine
T403 against Pseudomonas aeruginosa (ATCC #10145).
The MIC values are reported in ppm. The fold reduction over
the control without booster is reported in parenthesis.

Pseudomonas aeruginosa MIC, ppm
(Fold Reduction)

| | | Jeffamine T403 | | | |
|---|---|---|---|---|---|
| Test Biocide | 0% | 0.075% | | 0.15% | |
| Mergal K10N | 370 | 92 | (4) | 92 | (4) |
| Mergal CM1.5 | 74 | 19 | (4) | 19 | (4) |
| Troyshield FSP40 | 148 | 296 | (0.5) | 296 | (0.25) |

TABLE 2
MIC of three biocides alone and in combination with two dispersion-type
boosters against Pseudomonas aeruginosa (ATCC #10145).
The MIC values are reported in ppm. The fold reduction over
the control without booster is reported in parenthesis.

| | Pseudomonas aeruginosa MIC, ppm | | | | | | | | |
|---|---|---|---|---|---|---|---|---|---|
| | (Fold Reduction) | | | | | | | | |
| Test | | “1737-34” | | | | “1737-35” | | | |
| Biocide | 0 | 0.075% | | 0.15% | | 0.075% | | 0.15% | |
| Mergal K10N | 370 | 185 | (2) | 185 | (2) | 93 | (4) | 93 | (4) |
| Mergal CM1.5 | 148 | 37 | (4) | 37 | (4) | 18 | (8) | 18 | (8) |
| Troyshield | 296 | 296 | (1) | 592 | (0.5) | 2 | (128) | 2 | (170) |
| FSP40 | | | | | | | | | |

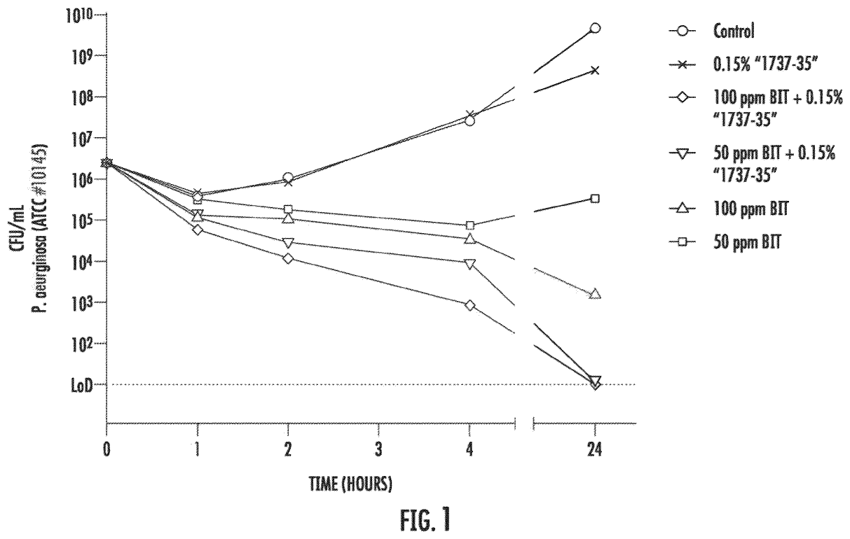

A kill curve was generated with Mergal K10N (10% BIT) at 500 and 1000 ppm loading levels (50 and 100 ppm BIT) with and without addition of 0.15% w/w of booster “1735-37.” Kill curves were performed with cultures of Pseudomonas aeruginosa (ATCC #10145) growing in Tryptic Soy Broth were diluted to OD₆₀₀=0.7 in Mueller Hinton Broth containing the indicated level of test compound. Time points were collected by adding 1 mL of the sample into 9 mL of Dey-Engley Neutralizing Broth and performing a serial dilution in 1× Butterfield's Phosphate Buffer. Counts were obtained from pour plates in Tryptic Soy Agar after overnight incubation at 35° C. Viability measurements were taken after 1, 2, 4, and 24 hours of incubation at 35° C. with biocide neutralization in 1× Dey-Engley broth and serial dilution onto plates. The test results (FIG. 1) show that after 24 hours, both concentrations of BIT show growth inhibition or reduction from the initial counts, but the combination of BIT and the booster achieves complete kill of Pseudomonas (<10 CFU/mL). The booster shows similar efficacy to the control, strongly suggesting the combination of the booster and BIT act synergistically to kill Pseudomonas.

### Example 2

To test whether the boosters were effective in coatings, bacterial challenge testing was performed using a consortium of industrially important bacterial isolates, such as Alcaligenes faecalis (ATCC #25094), Enterobacter aerogenes (ATCC #13048), Escherichia coli (ATCC #11229), Pseudomonas aeruginosa (ATCC #10145), Staphylococcus aureus (ATCC #6538), Microbacterium paraoxydans (Troy Isolate), Burkholderia cenocepacia (Troy Isolate), Citrobacter werkmanii (Troy Isolate), and Acinetobacter sp. (Troy Isolate). All bacteria were blended from separate overnight cultures grown in Tryptic Soy Broth (TSB) and mixed at equal CFU via OD₆₀₀ measurements, then diluted to OD₆₀₀=7 (˜109 CFU/mL) to create the final bacterial consortium. Each mixture was prepared shortly before each inoculation. Inoculations were performed by adding 0.1 mL to 50 g of the indicated test sample to give ˜10⁷ CFU/g per inoculation. Viability readings were performed at the indicated intervals following each challenge by applying a small amount of the test sample onto Tryptic Soy Agar (TSA). Plates were then incubated at 32° C. for 3-5 days before being evaluated with a semi-quantitative scale. This scale estimates the approximate CFU/g by visual assessment of the colony density along the streak lines. Readings are recorded as the average of two duplicate semi-quantitative readings from “0” to “4.” Samples were mixed before every viability reading and after every inoculation.

| Colony Count | Rating | Approximate CFU/g¹ |
|---|---|---|
| 0 | 0 | <1 |
| 1-10 | 1 | 10-10² |
| 11-100 | 2 | 10³-10⁴ |
| 101-1000 | 3 | 10⁴-10⁵ |
| >1000 | 4 | >10⁵ |

¹Lunenburg-Duindam, Jenny & Lindner, Wolfgang, In-can preservation of emulsion paints, European Coatings Journal, 66-73 (2000).

The challenge test results demonstrate that paint with up to 0.05% w/w Troyshield FSP40 or Mergal K10N are highly susceptible to bacterial contamination, and combination with between 0.1-0.4% w/w of “1737-35” improves the bacterial resistance over the baseline performance of the biocide in a dose-dependent matter (Table 3).

TABLE 3
Bacterial challenge test results of dispersion booster “1737-35” in
combination with low levels of BIT and NaPy in Interior Paint #1 (Ref
# U21-0108-2). The pass criteria is a “0” rating 7 days after each bacterial challenge.

| | Amount of | | Days after Bacterial Challenge | | | | | | | | |
|---|---|---|---|---|---|---|---|---|---|---|---|
| Amount of | “1737-35” | | Week 1 | | | Week 2 | | | Week 3 | | |
| Biocide Added | Added | # | 1 d | 2 d | 7 d | 1 d | 2 d | 7 d | 1 d | 2 d | 7 d |
| — | — | 1 | 3 | 4 | 4 | 4 | 4 | 4 | 4 | 4 | 4 |
| | 0.10 w/w % | 1.1 | 4 | 4 | 4 | 3 | 4 | 4 | 4 | 4 | 4 |
| | 0.20 w/w % | 1.2 | 3 | 2 | 4 | 3 | 4 | 4 | 4 | 4 | 4 |
| | 0.30 w/w % | 1.3 | 3 | 3 | 0 | 2 | 3 | 4 | 4 | 4 | 4 |
| | 0.40 w/w % | 1.4 | 2 | 2 | 0 | 3 | 1 | 0 | 3 | 2 | 0 |
| 0.015 w/w % | — | 1.5 | 4 | 4 | 4 | 4 | 4 | 3 | 4 | 4 | 4 |
| Mergal K10N | 0.10 w/w % | 1.6 | 4 | 3 | 4 | 4 | 4 | 3 | 4 | 3 | 4 |
| (15 ppm BIT) | 0.20 w/w % | 1.7 | 3 | 2 | 2 | 4 | 4 | 4 | 4 | 3 | 2 |
| | 0.30 w/w % | 1.8 | 4 | 3 | 2 | 3 | 3 | 4 | 4 | 4 | 4 |
| | 0.40 w/w % | 1.9 | 2 | 2 | 0 | 2 | 2 | 0 | 2 | 2 | 0 |
| 0.050 w/w % | — | 1.10 | 4 | 3 | 4 | 4 | 4 | 4 | 3 | 3 | 2 |
| Mergal K10N | 0.10 w/w % | 1.11 | 4 | 2 | 4 | 4 | 4 | 4 | 4 | 4 | 3 |
| (50 ppm BIT) | 0.20 w/w % | 1.12 | 4 | 2 | 0 | 4 | 4 | 4 | 4 | 4 | 4 |
| | 0.30 w/w % | 1.13 | 2 | 2 | 2 | 2 | 3 | 0 | 4 | 2 | 0 |
| | 0.40 w/w % | 1.14 | 2 | 2 | 0 | 2 | 2 | 0 | 2 | 2 | 0 |
| 0.025 w/w % | — | 1.15 | 3 | 3 | 3 | 3 | 3 | 4 | 4 | 4 | 4 |
| Troyshield FSP40 | 0.10 w/w % | 1.16 | 3 | 2 | 0 | 3 | 2 | 0 | 3 | 3 | 0 |
| (100 ppm NaPy) | 0.20 w/w % | 1.17 | 1 | 0 | 0 | 3 | 1 | 0 | 2 | 0 | 0 |
| | 0.30 w/w % | 1.18 | 1 | 0 | 0 | 3 | 1 | 0 | 2 | 0 | 0 |
| | 0.40 w/w % | 1.19 | 1 | 0 | 0 | 3 | 1 | 0 | 2 | 0 | 0 |
| 0.050 w/w % | — | 1.20 | 3 | 3 | 3 | 3 | 3 | 3 | 3 | 4 | 3 |
| Troyshield FSP40 | 0.10 w/w % | 1.21 | 3 | 2 | 0 | 3 | 2 | 0 | 3 | 3 | 1 |
| (200 ppm NaPy) | 0.20 w/w % | 1.22 | 2 | 0 | 0 | 3 | 2 | 0 | 2 | 0 | 0 |
| | 0.30 w/w % | 1.23 | 2 | 0 | 0 | 3 | 2 | 0 | 2 | 0 | 0 |
| | 0.40 w/w % | 1.24 | 0 | 0 | 0 | 3 | 1 | 0 | 2 | 0 | 0 |

### Example 3

A solution version of the multifunctional booster were produced while maintaining zero VOC content. Solutions “1737-67” and “1737-72” were produced by combination of Jeffamine T403, glycerin, and potassium methyl siliconate with varying levels of zinc acetate and water.

| | |
|---|---|
| Chemical Name | Percentage |

Ref - “1737-67”

| | |
|---|---|
| Jeffamine T403 | 60% |
| Glycerin | 24.5% |
| Zinc acetate | 0.5% |
| Potassium Methyl | 3.0% |
| Siliconate | |
| Water, distilled | 12.0% |

Ref- “1737-72”

| | |
|---|---|
| Jeffamine T403 | 60% |
| Glycerin | 24.5% |
| Zinc acetate | 1.5% |
| Potassium Methyl | 3.0% |
| Siliconate | |
| Water, distilled | 11.0% |

As in Example 1, testing started by assaying the boosting activity of “1737-67” and “1737-72” with Mergal K10N, Mergal CM1.5, and Troyshield FSP40. The testing was carried out as described for the dispersion-type versions. The test results (Table 4) shows that both versions can significantly boost Mergal CM1.5 (CMIT/MIT) and Mergal K10N (BIT), but only the version with higher zinc acetate content can boost Troyshield FSP40 (sodium pyrithione). Notably, “1737-72” was a more effective booster than Jeffamine T403 and dispersion-booster “1737-35.”

TABLE 4
MIC of three biocides alone and in combination with two clear
solution boosters against Pseudomonas aeruginosa (ATCC #10145).
“1737-67” contains 60% Jeffamine T403, 3% potassium methyl
siliconate, and 0.5% zinc acetate, and “1737-72” contains
60% Jeffamine T403, 3% potassium methyl siliconate, and 1.5%
zinc acetate. The MIC values are reported in ppm. The fold reduction
over the control without booster is reported in parenthesis.

| | Pseudomonas aeruginosa MIC, ppm | | | | | | | | |
|---|---|---|---|---|---|---|---|---|---|
| | (Fold Reduction) | | | | | | | | |
| Test | | “1737-67” | | | | “1737-72” | | | |
| Biocide | 0 | 0.075% | | 0.15% | | 0.075% | | 0.15% | |
| Mergal | 370 | 93 | (4) | 93 | (4) | 46 | (8) | 46 | (8) |
| K10N | | | | | | | | | |
| Mergal | 111 | 18 | (6) | 18 | (6) | 2 | (56) | 2 | (56) |
| CM1.5 | | | | | | | | | |
| Troyshield | 296 | 296 | (1) | 296 | (1) | 148 | (2) | ≤1 | (≥296) |
| FSP40 | | | | | | | | | |

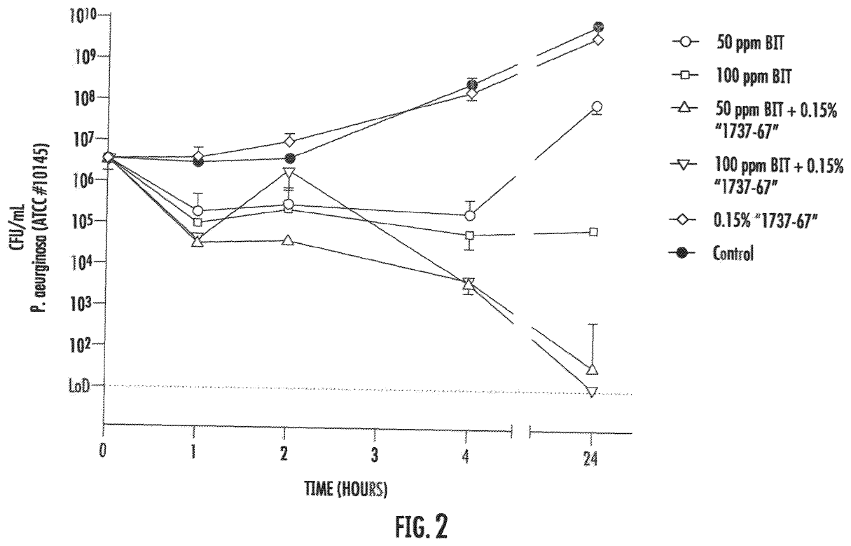

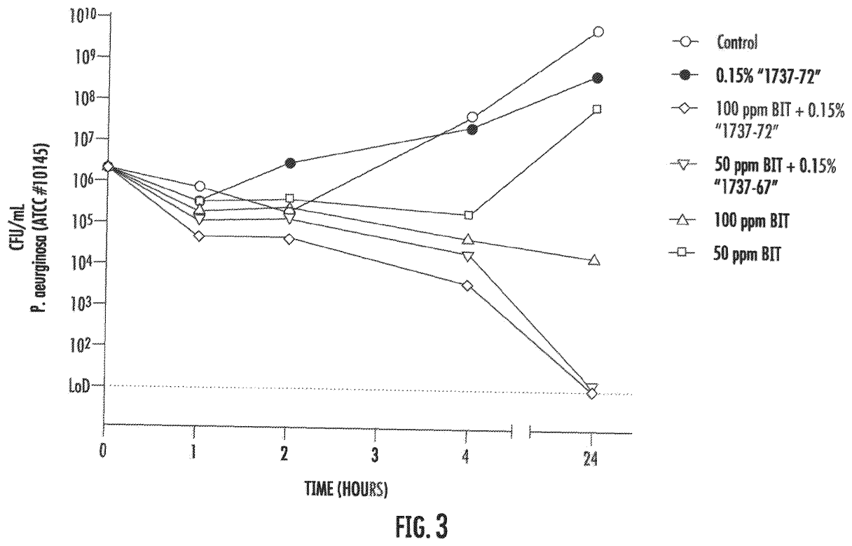

The activity of the clear solution boosters was characterized further. Kill curves were generated with the same procedure as done with the dispersion booster “1737-35” (FIG. 1) but using “1737-67.” Testing shows that “1737-67” itself has no activity at 0.15% w/w but significantly improves the activity of 50 ppm and 100 ppm BIT (FIG. 2). The boosting kill curve results are similar to the dispersion version “1737-35.” The solution version containing 1.5% zinc acetate (“1737-72”) has similar boosting activity (FIG. 3).

Bacterial challenge testing was carried out as described in Example 2 but with the solution versions “1737-67” and “1737-72,” again aimed at examining improvements in the bacterial resistance of paint preserved with low levels of BIT and NaPy. As done for the dispersion-booster “1737-35,” the level of BIT was chosen at 15 and 50 ppm and the level of NaPy was chosen at 100 and 200 ppm. The challenge results demonstrate that both boosters are effective at boosting BIT and NaPy at low levels, but consistent with the MIC experiments (Table 4), “1737-72” is significantly more effective at boosting NaPy than “1737-67” (Table 5, 6).

TABLE 5
Bacterial challenge test results of solution booster “1737-67” in combination
with low levels of BIT and NaPy in Test Paint Formulation #1 (Ref #
U21-0108-2). The pass criteria is a “0” rating 7 days after each bacterial challenge.

| | Amount of | | Days after Bacterial Challenge | | | | | | | | |
|---|---|---|---|---|---|---|---|---|---|---|---|
| Amount of | “1737-67” | | Week 1 | | | Week 2 | | | Week 3 | | |
| Biocide Added | Added | # | 1 d | 2 d | 7 d | 1 d | 2 d | 7 d | 1 d | 2 d | 7 d |
| — | — | 1 | 4 | 4 | 3 | 3 | 4 | 3 | 4 | 4 | 4 |
| | 0.10 w/w % | 1.1 | 4 | 4 | 4 | 4 | 4 | 3 | 4 | 4 | 4 |
| | 0.20 w/w % | 1.2 | 4 | 4 | 4 | 4 | 4 | 2 | 4 | 4 | 2 |
| | 0.30 w/w % | 1.3 | 3 | 4 | 4 | 4 | 4 | 4 | 4 | 4 | 3 |
| | 0.40 w/w % | 1.4 | 2 | 1 | 3 | 4 | 4 | 4 | 4 | 4 | 4 |
| 0.015 w/w % | — | 1.5 | 4 | 4 | 4 | 4 | 4 | 3 | 4 | 4 | 4 |
| Mergal K10N | 0.10 w/w % | 1.6 | 4 | 4 | 4 | 4 | 4 | 3 | 4 | 4 | 4 |
| (15 ppm BIT) | 0.20 w/w % | 1.7 | 4 | 4 | 4 | 4 | 4 | 3 | 4 | 4 | 4 |
| | 0.30 w/w % | 1.8 | 4 | 2 | 3 | 4 | 3 | 4 | 4 | 4 | 4 |
| | 0.40 w/w % | 1.9 | 2 | 0 | 0 | 2 | 0 | 0 | 2 | 1 | 0 |
| 0.050 w/w % | — | 1.10 | 4 | 3 | 4 | 4 | 4 | 3 | 3 | 3 | 2 |
| Mergal K10N | 0.10 w/w % | 1.11 | 4 | 3 | 4 | 4 | 4 | 3 | 3 | 2 | 4 |
| (50 ppm BIT) | 0.20 w/w % | 1.12 | 2 | 1 | 0 | 2 | 1 | 0 | 3 | 1 | 0 |
| | 0.30 w/w % | 1.13 | 2 | 1 | 0 | 2 | 0 | 0 | 2 | 1 | 0 |
| | 0.40 w/w % | 1.14 | 2 | 1 | 0 | 2 | 1 | 0 | 2 | 2 | 0 |
| 0.025 w/w % | — | 1.15 | 3 | 4 | 3 | 4 | 4 | 4 | 4 | 4 | 4 |
| Troyshield FSP40 | 0.10 w/w % | 1.16 | 3 | 4 | 3 | 4 | 4 | 4 | 4 | 4 | 4 |
| (100 ppm NaPy) | 0.20 w/w % | 1.17 | 3 | 3 | 3 | 4 | 4 | 4 | 4 | 4 | 4 |
| | 0.30 w/w % | 1.18 | 2 | 0 | 0 | 3 | 3 | 4 | 4 | 4 | 4 |
| | 0.40 w/w % | 1.19 | 1 | 3 | 0 | 4 | 4 | 4 | 4 | 4 | 4 |
| 0.050 w/w % | — | 1.20 | 4 | 4 | 3 | 4 | 4 | 4 | 4 | 4 | 4 |
| Troyshield FSP40 | 0.10 w/w % | 1.21 | 4 | 3 | 2 | 4 | 4 | 1 | 3 | 4 | 1 |
| (200 ppm NaPy) | 0.20 w/w % | 1.22 | 4 | 3 | 0 | 4 | 4 | 1 | 3 | 4 | 1 |
| | 0.30 w/w % | 1.23 | 4 | 2 | 0 | 3 | 3 | 0 | 4 | 3 | 0 |
| | 0.40 w/w % | 1.24 | 2 | 1 | 0 | 2 | 0 | 0 | 3 | 3 | 0 |

TABLE 6
Bacterial challenge test results of solution booster “1737-72” in combination
with low levels of BIT and NaPy in Test Paint Formulation #1 (Ref #
U21-0108-2). The pass criteria is a “0” rating 7 days after each bacterial challenge.

| | Amount of | | Days after Bacterial Challenge | | | | | | | | |
|---|---|---|---|---|---|---|---|---|---|---|---|
| Amount of | “1737-72” | | Week 1 | | | Week 2 | | | Week 3 | | |
| Biocide Added | Added | # | 1 d | 2 d | 7 d | 1 d | 2 d | 7 d | 1 d | 2 d | 7 d |
| — | — | 1 | 4 | 4 | 4 | 4 | 4 | 4 | 4 | 4 | 4 |
| | 0.10 w/w % | 1.1 | 4 | 4 | 4 | 4 | 4 | 4 | 4 | 4 | 4 |
| | 0.20 w/w % | 1.2 | 4 | 4 | 4 | 4 | 4 | 4 | 4 | 4 | 4 |
| | 0.30 w/w % | 1.3 | 3 | 1 | 0 | 4 | 4 | 4 | 4 | 4 | 4 |
| | 0.40 w/w % | 1.4 | 2 | 1 | 0 | 4 | 3 | 4 | 4 | 4 | 4 |
| 0.015 w/w % | — | 1.5 | 4 | 4 | 4 | 4 | 4 | 3 | 3 | 3 | 3 |
| Mergal K10N | 0.10 w/w % | 1.6 | 4 | 4 | 4 | 4 | 4 | 4 | 4 | 4 | 4 |
| (15 ppm BIT) | 0.20 w/w % | 1.7 | 3 | 3 | 3 | 4 | 4 | 4 | 4 | 3 | 3 |
| | 0.30 w/w % | 1.8 | 2 | 2 | 0 | 2 | 1 | 0 | 4 | 4 | 4 |
| | 0.40 w/w % | 1.9 | 2 | 1 | 0 | 4 | 4 | 3 | 4 | 4 | 4 |
| 0.050 w/w % | — | 1.10 | 3 | 3 | 4 | 4 | 4 | 4 | 4 | 4 | 4 |
| Mergal K10N | 0.10 w/w % | 1.11 | 3 | 2 | 0 | 3 | 2 | 4 | 4 | 4 | 4 |
| (50 ppm BIT) | 0.20 w/w % | 1.12 | 3 | 2 | 0 | 2 | 2 | 4 | 4 | 4 | 4 |
| | 0.30 w/w % | 1.13 | 2 | 1 | 0 | 2 | 2 | 0 | 2 | 3 | 4 |
| | 0.40 w/w % | 1.14 | 2 | 1 | 0 | 3 | 2 | 0 | 2 | 2 | 0 |
| 0.025 w/w % | — | 1.15 | 4 | 4 | 3 | 4 | 3 | 4 | 4 | 4 | 4 |
| Troyshield FSP40 | 0.10 w/w % | 1.16 | 3 | 4 | 4 | 4 | 4 | 4 | 4 | 4 | 4 |
| (100 ppm NaPy) | 0.20 w/w % | 1.17 | 2 | 1 | 0 | 2 | 2 | 0 | 4 | 1 | 0 |
| | 0.30 w/w % | 1.18 | 2 | 0 | 0 | 2 | 0 | 0 | 2 | 0 | 0 |
| | 0.40 w/w % | 1.19 | 1 | 0 | 0 | 2 | 0 | 0 | 2 | 0 | 0 |
| 0.050 w/w % | — | 1.20 | 3 | 3 | 3 | 4 | 3 | 3 | 4 | 4 | 3 |
| Troyshield FSP40 | 0.10 w/w % | 1.21 | 3 | 3 | 0 | 3 | 3 | 1 | 3 | 4 | 2 |
| (200 ppm NaPy) | 0.20 w/w % | 1.22 | 3 | 1 | 0 | 3 | 3 | 0 | 3 | 3 | 1 |
| | 0.30 w/w % | 1.23 | 2 | 0 | 0 | 2 | 0 | 0 | 2 | 1 | 0 |
| | 0.40 w/w % | 1.24 | 2 | 0 | 0 | 2 | 0 | 0 | 2 | 0 | 0 |

### Example 4

The booster “1737-72” may be combined with additional ingredients to enhance its performance as a multifunctional ingredient. AMP95 (2-amino-2-methyl-1-propanol) is a common ingredient used as a pH adjuster and buffer in paint formulations. To ensure a blend of AMP95 with “1737-72” would remain highly functional as a booster, MIC boosting experiments and bacterial challenge testing was performed. AMP95 was mixed with “1737-72” at 1:1 based on weight % and produced a transparent homogenous solution without precipitate. This solution was used for testing.

MIC experiments show that the booster lowers the MIC of BIT and CMIT/MIT by 2-fold at both 0.075 and 0.15% w/w and lowers the MIC of sodium pyrithione at 0.15% w/w by 64-fold (Table 7).

TABLE 7
MIC of three biocides alone and in combination with a
combination of a 1:1 mixture of “1737-72” and AMP95
against Pseudomonas aeruginosa (ATCC #10145).
The MIC values are reported in ppm. The fold reduction
over the control without booster is reported in parenthesis.

Pseudomonas aeruginosa MIC, ppm
(Fold Reduction)

| | | “1737-72”:AMP95 (1:1) | | | |
|---|---|---|---|---|---|
| Test Biocide | 0 | 0.075% | | 0.15% | |
| Mergal K10N | 370 | 185 | (2) | 185 | (2) |
| Mergal CM1.5 | 74 | 37 | (2) | 37 | (2) |
| Troyshield FSP40 | 296 | 296 | (1) | 4 | (64) |

Bacterial challenge testing on the combination of “1737-72” and AMP95 showed strong boosting results of low levels of BIT and sodium pyrithione (Table 8).

TABLE 8
Bacterial challenge test results of solution booster [“1737-72”:AMP95]
(1:1) in combination with low levels of BIT and NaPy in Interior Paint #1
(Ref # U21-0108-2). The pass criteria is a “0” rating 7 days after each bacterial challenge.

| | Amount of | | Days after Bacterial Challenge | | | | | | | | |
|---|---|---|---|---|---|---|---|---|---|---|---|
| Amount of | “1737-72”:AMP95 | | Week 1 | | | Week 2 | | | Week 3 | | |
| Biocide Added | (1:1) Added | # | 1 d | 2 d | 7 d | 1 d | 2 d | 7 d | 1 d | 2 d | 7 d |
| — | — | 1 | 4 | 4 | 4 | 4 | 4 | 4 | 4 | 4 | 4 |
| | 0.10 w/w % | 1.1 | 4 | 4 | 4 | 4 | 4 | 4 | 4 | 4 | 3 |
| | 0.20 w/w % | 1.2 | 4 | 3 | 3 | 3 | 3 | 2 | 4 | 4 | 4 |
| | 0.30 w/w % | 1.3 | 3 | 3 | 0 | 3 | 2 | 0 | 3 | 2 | 0 |
| | 0.40 w/w % | 1.4 | 3 | 3 | 0 | 3 | 3 | 0 | 3 | 2 | 0 |
| 0.015 w/w % | — | 1.5 | 4 | 4 | 4 | 4 | 4 | 4 | 4 | 4 | 4 |
| Mergal K10N | 0.10 w/w % | 1.6 | 4 | 3 | 4 | 4 | 4 | 4 | 4 | 4 | 4 |
| (15 ppm BIT) | 0.20 w/w % | 1.7 | 3 | 3 | 0 | 3 | 3 | 3 | 4 | 4 | 3 |
| | 0.30 w/w % | 1.8 | 3 | 3 | 0 | 3 | 2 | 0 | 3 | 1 | 0 |
| | 0.40 w/w % | 1.9 | 3 | 3 | 0 | 3 | 3 | 0 | 3 | 2 | 0 |
| 0.050 w/w % | — | 1.10 | 4 | 4 | 4 | 4 | 4 | 4 | 4 | 4 | 3 |
| Mergal K10N | 0.10 w/w % | 1.11 | 4 | 3 | 4 | 4 | 4 | 4 | 4 | 4 | 3 |
| (50 ppm BIT) | 0.20 w/w % | 1.12 | 4 | 3 | 0 | 3 | 3 | 0 | 3 | 2 | 2 |
| | 0.30 w/w % | 1.13 | 3 | 3 | 2 | 3 | 3 | 0 | 3 | 2 | 0 |
| | 0.40 w/w % | 1.14 | 3 | 3 | 0 | 2 | 3 | 0 | 3 | 2 | 0 |
| 0.025 w/w % | — | 1.15 | 4 | 4 | 4 | 4 | 4 | 4 | 4 | 4 | 4 |
| Troyshield FSP40 | 0.10 w/w % | 1.16 | 4 | 3 | 0 | 4 | 3 | 0 | 4 | 3 | 0 |
| (100 ppm NaPy) | 0.20 w/w % | 1.17 | 2 | 0 | 0 | 2 | 2 | 0 | 3 | 0 | 0 |
| | 0.30 w/w % | 1.18 | 2 | 0 | 0 | 2 | 0 | 0 | 2 | 0 | 0 |
| | 0.40 w/w % | 1.19 | 3 | 2 | 0 | 2 | 0 | 0 | 2 | 0 | 0 |
| 0.050 w/w % | — | 1.20 | 4 | 4 | 3 | 4 | 4 | 4 | 4 | 4 | 4 |
| Troyshield FSP40 | 0.10 w/w % | 1.21 | 4 | 3 | 2 | 4 | 4 | 2 | 4 | 4 | 2 |
| (200 ppm NaPy) | 0.20 w/w % | 1.22 | 3 | 2 | 0 | 3 | 2 | 0 | 3 | 1 | 0 |
| | 0.30 w/w % | 1.23 | 3 | 2 | 0 | 3 | 1 | 0 | 3 | 0 | 0 |
| | 0.40 w/w % | 1.24 | 2 | 0 | 0 | 2 | 0 | 0 | 2 | 0 | 0 |

### Example 5

The multifunctional benefits of Jeffamine T403 and T403 composition “1737-32” were measured.

An Acronal Edge 4750 No VOC semi-gloss architectural paint formulation was formulated for this project based on Acronal Edge 4750 resin starting point formulation. The samples were prepared as follows:
A total of 1100-gram master batch samples of paint were prepared each time a formulation was made with different experimental additive loading. Calculations and adjustments were made during the process in the grind phase.
Grind Phase: blended components with a high-speed disperser at 2760 RPM for 20 minutes to reach a particle size of 7-7.5 Hegman as reference. “1737-72” and Jeffamine T-403 use levels 0.20%-0.40% on total formulation were used in the grind, and water content was adjusted in the letdown.
Letdown Phase: formulation components were blended for 15 minutes at 1897 RPM.
Coating properties were evaluated 24 hours after paints equilibrated overnight and monitored for 8 weeks.
Subsequently, each master batch was divided into 4×½ pint phenolic epoxy lined cans and evaluated after heat aging for 2, 4, 6 and 8 weeks.

TABLE 9
Acronal Edge 4750 No VOC Semi-gloss Paint Formulation (Control Base)
Acronal Edge 4750 No VOC Semi-gloss Paint (0.20%) AMP-95

| | | Batch size | Raw material |
|---|---|---|---|
| Raw Materials | % | (1100 g) | Description |
| DI Water | 5.68 | 62.49 | Vehicle |
| Mergal ® 758 | 0.29 | 3.23 | Preservative |
| Troykyd ® D209W | 0.20 | 2.20 | Defoamer |
| AMP-95 ™ | 0.20 | 2.16 | pH Adjuster |
| Tamol ™ 1124 | 0.49 | 5.39 | Dispersing Agent |
| Polygloss ® 90 | 2.94 | 32.35 | Filler |
| Attagel ® 50 | 0.20 | 2.16 | Thickener |

Grind for 15-20 minutes, reduce speed, then add:

| | | | |
|---|---|---|---|
| DI Water | 11.33 | 124.64 | Vehicle |
| Troykyd ® D209W | 0.10 | 1.10 | Defoamer |
| Troysol ™ ZLAC | 0.39 | 4.31 | Wetting Additive |
| Loxanol ® CA 5120 | 1.96 | 21.56 | Coalescing Agent |
| Ti-Pure ™ R-746 | 27.44 | 301.90 | TiO2 Dispersion |
| Acronal ® Edge 4750 | 46.55 | 512.15 | Binder |
| Rheovis ® PE1331 | 1.63 | 17.89 | Rheology Modifier |
| Polyphase ® 678 | 0.59 | 6.47 | Preservative |
| Total | 100 | 1100 | |

The samples prepared from the paints are referred to as follows:

| Troy Code | Sample Type |
|---|---|
| U21-0108-2 | Interior Paint #1 |
| U210533-01 | Acronal ® Edge 4750 No VOC Semi-gloss |
| | Paint (0.20%) AMP-95 (Control) |
| U210533-02 | 0.20% 1737-72(T-403 Mixture) |
| U210533-03 | 0.40% 1737-72 (T-403 Mixture) |
| U210533-04 | 0.20% Jeffamine T-403 Neat (Huntsman) |
| U210533-05 | 0.40% Jeffamine T-403 Neat (Huntsman) |

### Film Application

Films were prepared from the aqueous samples and applied to sealed Leneta Penopac Charts, Form 1B, using a 3 mil Bird Film Applicator®. The charts were held in place with a vacuum plate to ensure a uniform film thickness. The films were dried at ambient temperature for 24 hours.

Color measurements of the test films were made with a DataColor Check 3 spectrophotometer Model LAV/USAA C₃₁₅₆₇ to obtain CIE L*, a*, b* and YI-E313 data for CIELAB color space based on perception. The YI-E313, yellowness index, was recorded in order to determine the degree in which the sample's color shifts away from an ideal white.

### Gloss and Film Defects

Paint films were applied to Leneta Penopac Charts, Form 1B with a 3 mil Bird Film Applicator and allowed to dry for 1 day, Gloss was measured at 20°, 60° and 85° on the sealed section of the chart. Gloss measurements of the dried films were taken using an Elcometer 408 Gloss and DOI Meter. The gloss was measured within 3 points of reference and the average value was recorded. Film defects were evaluated at a magnification of 10× using a MEIJI EMZ-TR light microscope.

Contrast Ratio or Ro/Rw Ratio: The division between the L* reflectance value of a paint film over the black area (Ro) of Leneta Form 1A Penopac Chart and the L* reflectance value of the white sealed area (Rw) on the same chart and of the same sample, as described in ASTMD2508, Standard Test Method for Hiding of Paints by Reflectometry.

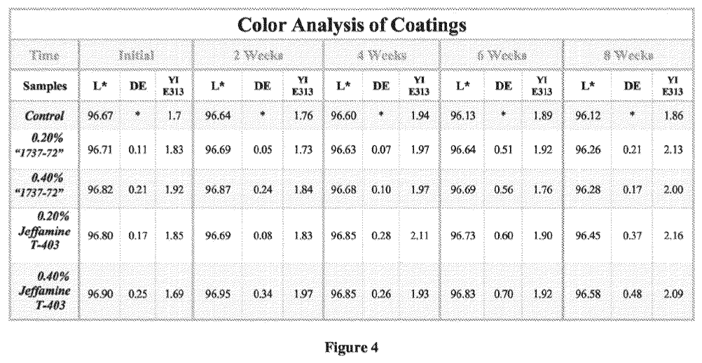

Color measurements of the test films were made with a DataColor Check 3 spectrophotometer Model LAV/USAA C31567 to obtain CIE L*, a*, b* and YI-E313 data for CIELAB color space based on perception. The YI-E313, yellowness index, was recorded in order to determine the degree in which the sample's color shifts away from an ideal white. FIG. 4 displays the color analysis recorded for the 8 weeks on the laboratory trials tested in this study. Coatings containing “1737-72” & Jeffamine® T-403 displayed a slight minor increase in L* values versus the control, exhibiting negligible effects on color and no apparent co-dispersant properties due to the small increase of less than 0.6 units. All samples exhibited similar yellowing profile in the initial evaluation. As samples aged, the YI-313 values increased but did not surpass the 2.2%. Therefore, no notable contribution to yellowing to dry films were noted since the Control (U210533-01) yellowed at a similar rate. 0.20% “1737-72” (U210533-02) displayed the lowest DE-values which is considered the smallest change from Control. Overall, in comparison to the control, the incorporation of “1737-72” and Jeffamine® T-403 did not compromise dry film properties.

### Example 6

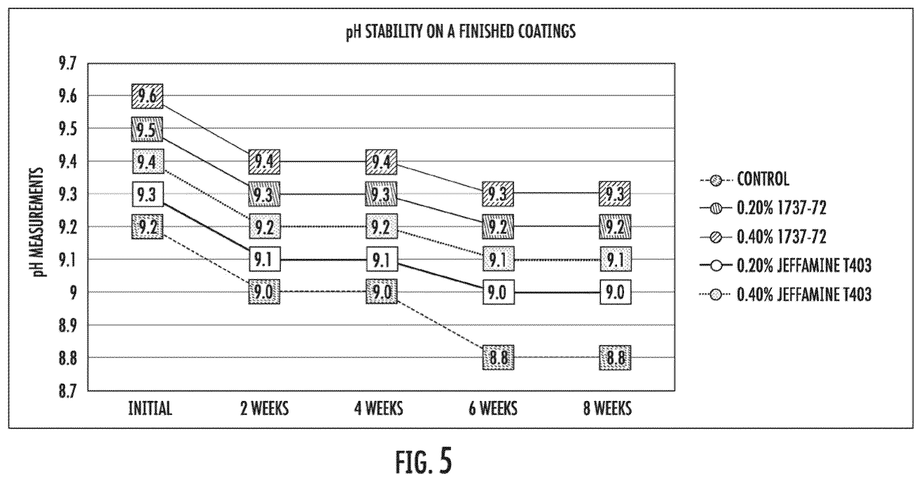

pH measurements were evaluated using a Thermos Scientific Orion Star® A111 pH meter and re-confirmed with a Hanna Instruments HI2550 pH/ORP and TDS PH meter. All evaluation were done in duplicate to assure accuracy of pH values. FIG. 5 indicates the effectiveness of “1737-72” and Jeffamine® T-403 as pH boosters and pH stabilizers. 0.2% “1737-72” (U210533-02) and 0.4% “1737-72” (U210533-03) provided the highest boost in pH at 0.3 and 0.4 units, respectively, and up to 0.5 units at the 6- and 8-week heat age intervals. While seemingly not much, this slight boost is enough for a formulator to be aware and understand that the addition of this product may result in having to cut back slightly on the conventional pH adjuster loading in order to bring the coating pH into spec. 0.20% of Jeffamine T-403 (U210533-04) and 0.40% of Jeffamine T-403 (U210533-05) also displayed positive results, but at a much lower rate. Control sample (U210533-01) containing an optimized use level of AMP-95™ as the conventional pH adjuster. All samples showed pH stability over time. Alkaline stability is essential when formulating since issues as vehicle stability, package corrosion, viscosity profile and pigment dispersion stability can be drastically compromised.

### Example 7

The fineness of grind was measured in accordance with ASTM D1210, Standard Test Method for Fineness of Dispersion of Pigment-Vehicle Systems by Hegman-Type Gage. The results were reported in Hegman units as well as in microns using a grind gage from Precision Gage and Tool Company.

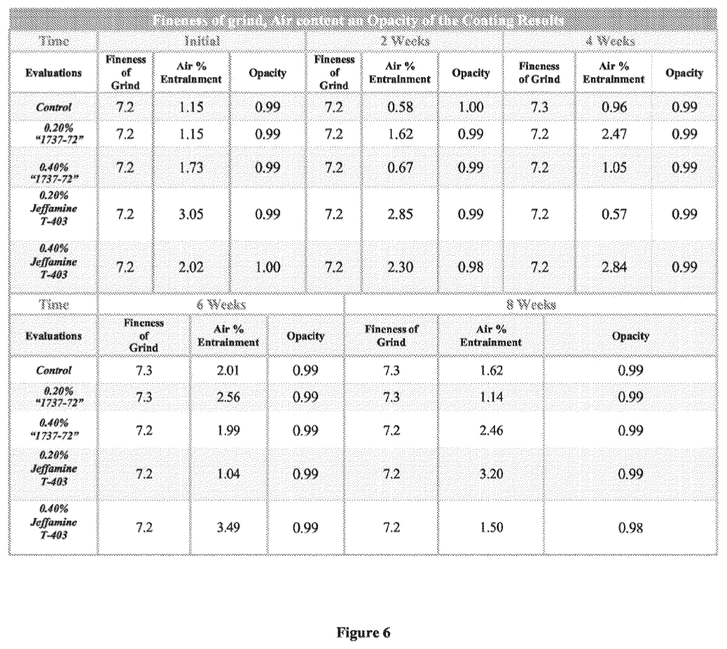

FIG. 6 displays the fineness of grind, air content and opacity of the coatings. These properties are developed in the grind phase of coating production. All master batches presented similar particle size profiles at the initial readings of 7.2 Hegman (10μ microns). No significant enhancements or negative impacts occurred within the particle size of the coating over time. Contrast ratio values, which describe opacity, exhibited parallel results with all the samples and negligible changes were observed upon heat aging. No notable benefits or adverse effects on air release or air entrainment properties where noted. However, samples 0.20% Jeffamine T-403 (U210533-04) and 0.40% Jeffamine T-403 (U210533-05) did exhibit slightly higher air entrainment. No film defects due to entrapped air were observed.

### Example 8

Krebs Units (KU) viscosity measurements were performed in accordance with ASTM D562, Standard Test Method for Consistency of Paints Using the Stormer Viscometer. ICI viscosity measurements were performed in accordance with ASTM D4287, Standard Test Method for High-Shear Viscosity Using the ICI Cone/Plate Viscometer model 106-110v-60HZ at a temperature of 25° C.

Coating samples were heat aged at 50° C. in a Thermo Scientific Heratherm OMS 180 Model #41298000 convection oven for 2, 4, 6 and 8 weeks. Coating samples were allowed to equilibrate to room temperature after removal from the oven before measuring viscosity.

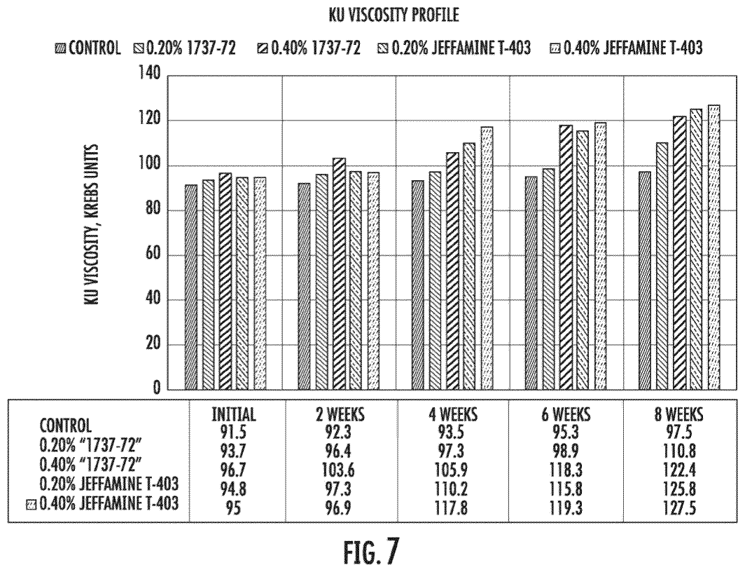

FIG. 7 chart describes the viscosity profile of all samples tested within 8 weeks. Initial evaluations displayed a similar viscosity profile. Aged coatings containing 0.20% “1737-72” (U210533-02) and 0.40% “1737-72” (U210533-03) presented a higher profile than the control sample by 13 and 25 units respectively. 0.20% Jeffamine T-403 (U210533-04) and 0.40% Jeffamine T-403 (U210533-05) had a much higher impact on viscosity stability and both loadings increased viscosity by 30 units during heat exposure.

### Example 9

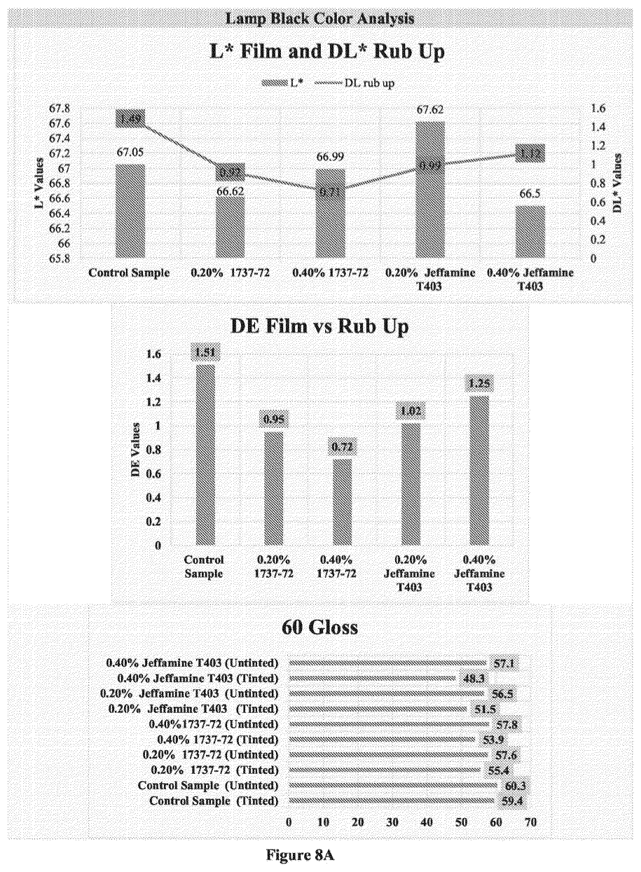

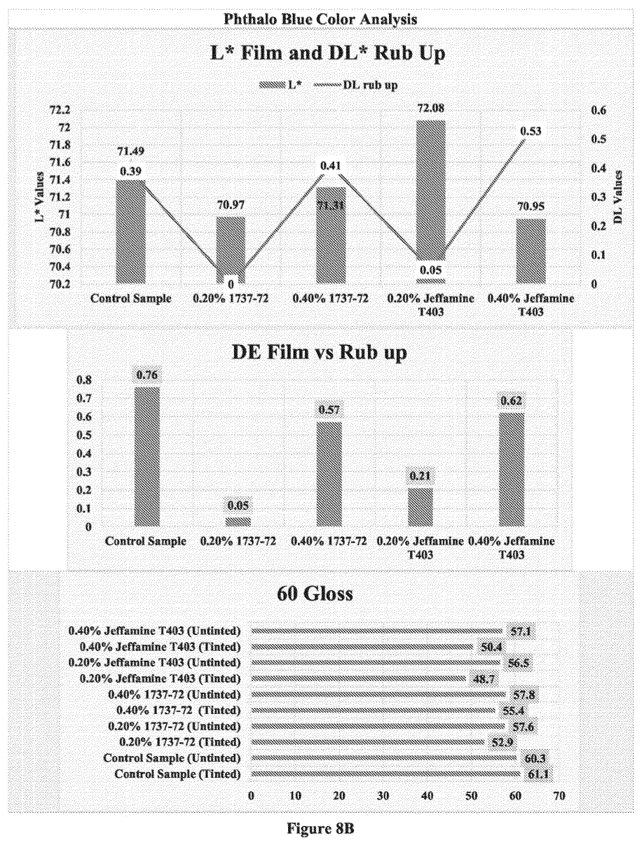

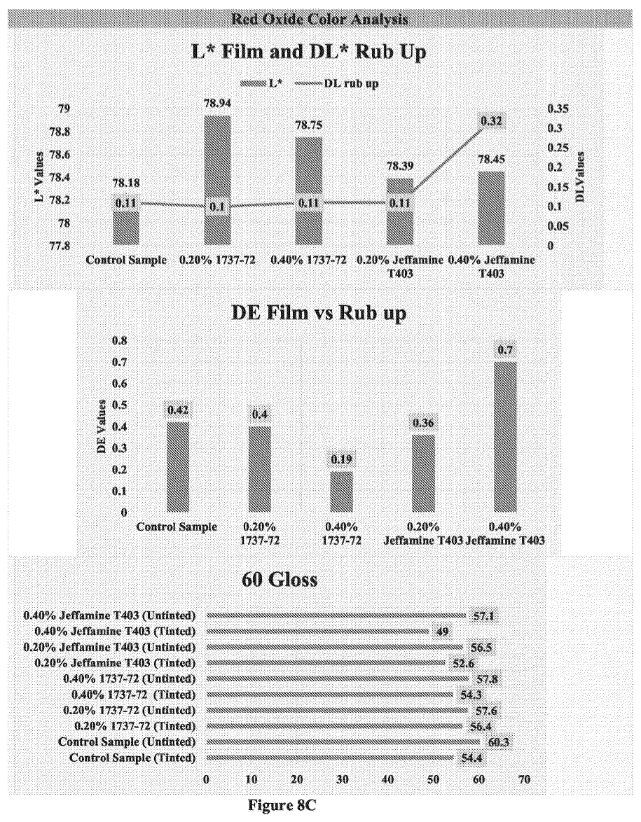

Color acceptance was performed by tinting the test paints with BASF Pure Options® low VOC universal colorants in lamp black, phthalo blue and red oxide at 2.5% by weight, representing a variety of pigment chemistries, color spectrums and dispersant/surfactant packages. FIG. 8A displays lamp black results. 0.20% “1737-72” (U210533-02) and 0.40% “1737-72” (U210533-03) improved the color acceptance properties showing minimal change in DL* values when a rub-up friction was performed. Delta-E values followed a similar trend. Low DL* and DE values in a rub up test strongly suggest improved color acceptance. 0.20% Jeffamine T-403 (U210533-4) and 0.40% Jeffamine T-403 (U210533-05) also displayed good color acceptance in comparison to the control but not as effective as “1737-72”. A reduction in gloss was observed in the tinted versus untinted base paints, which is normal and may be within parameters. Tinted samples containing Jeffamine T-403 had lower gloss readings (up to 10 units) than those containing “1737-72” when compared to the control and may be a sign of some type of incompatibility. Similar trends were observed with FIG. 8B phthalo blue and FIG. 8C pigment dispersions

### Example 10

Test paint was applied with a 7-mil Bird Film Applicator® to 165×432 mm vinyl chloride/acetate copolymer panels and 3 different panels. After curing for 7 days, the 2 best panels were selected and each placed on straight line washability machine Gardco Model #D10-WA-2151 with a brass shim (12.7 by 0.25-mm) under the panel. A nylon brush with bristles in a 5/4 pattern extending 19 mm from block was placed on the brush holder and the number of cycles that form a break in the coating was recorded. Test measurements were performed in accordance with ASTM D2486, Standard Test Methods for Scrub Resistance of wall paints.

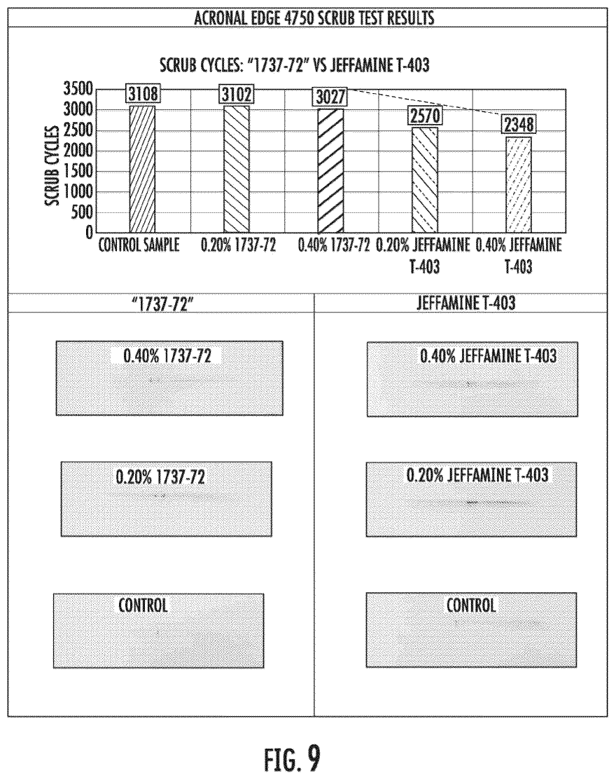

FIG. 9 illustrates scrub resistance properties, or the resistance of wall paints to erosion caused by scrubbing, determined by the traditional cycle-to-failure concept. 0.20% of “1737-72” (U210533-02) and 0.40% “1737-72” (U210533-03) showed no significant changes in scrub resistance versus the control. While 0.4% “1737-72” shows only very slight decline, higher doses may compromise endurance to erosion as seen in neat Jeffamine T-403 data. 0.20% Jeffamine T-403 (U210533-04) and 0.40% of Jeffamine T-403 (U210533-05) showed lower endurance to erosion with differences of 538 cycles and 760 cycles respectively versus the control. Even though the repeatability for this test was acceptable at up to 30%, raw data among the trials were consistent with little variation.

### Example 11

Test paint was applied with a 7-mil Bird Film Applicator® to 165×432 mm vinyl chloride/acetate copolymer panels and 3 different panels. After curing for 7 days, the best 2 panels were selected, and common household stains were applied to each panel in the following order: (1) leneta stain media ST-1, (2) grape juice, (3) mustard, (4) coffee, (5) red marker, (6) wine, (7) purple marker, (8) lipstick, (9) black tea and (10) ketchup. The stains were allowed to dry for 1 hour at the room temperature. Subsequently, panels were place on straight-line washability machine Gardco Model #D10-WA-2151 where a sponge was placed on the brush holder; Liquid cleanser was applied on film and washed for up to 100 cycles. Test measurements were performed in accordance with ASTM D4828, Standard Test Methods for Practical Washability of Organic Coatings.

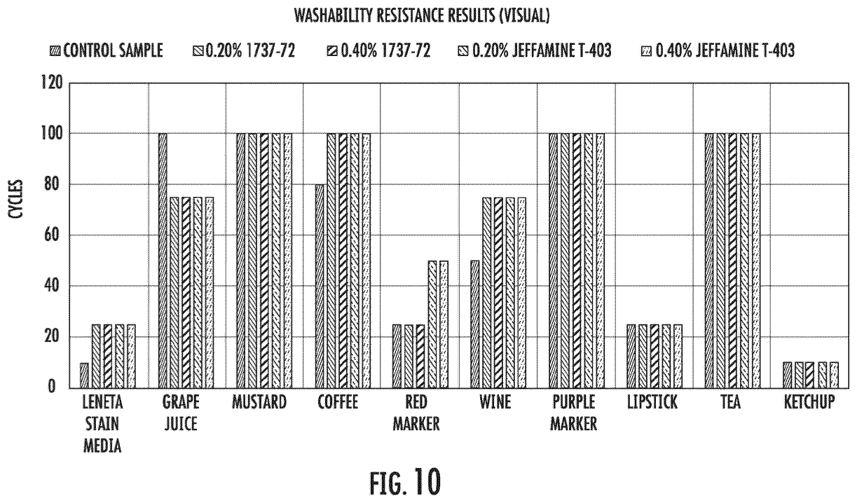

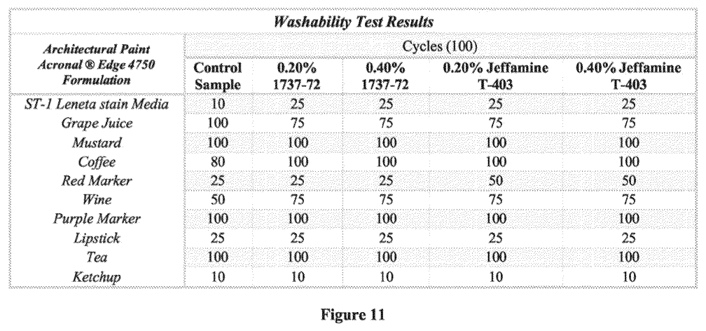

FIGS. 10 and 11 panels were evaluated at up to 100 cycles on the mechanical washing tester to check for the relative ease of removal of common household stains. Evaluations on color or erosion of test films was conducted visually. Results show how stains on paint films containing “1737-72” and Jeffamine® T-403 presented generally parallel effects on stain resistance in comparison to Control (U210533-01). Leneta stain media ST1, coffee and wine stains were slightly more difficult to remove from the dosed paints requiring extra cycles for complete removal.

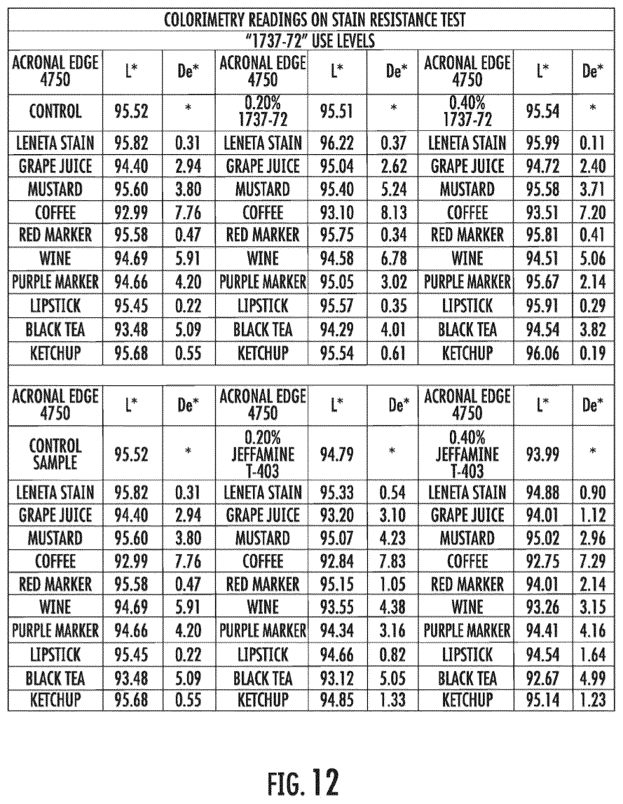

FIG. 12 correlates the visual observations in FIGS. 10 and 11 with color analysis on each stain. Results showed that, in general, there were no notable changes in stain resistance. Some stains had slightly higher or slightly lower variations in L*, DL* and DE versus the performance of the control, but no significant advantages or disadvantages were observed. Some slight enhancements to note with “1737-72” are purple marker and tea stains. Slight enhancements to note with T-403 are grape juice, red marker and red wine.

### Example 12

Using ASTM D4587-11 (2019), Standard Practice for Fluorescent UV-Condensation Exposures of Paint and Related Coatings, the five coatings were tested for 500 hours total with color measurements at initial and final intervals. The QUV cabinet was programmed as follows:

QUV Programming

| | | Temperature | Time | Light Intensity |
|---|---|---|---|---|
| Step | Function | (° C.) | (Hours) | (W/m² at 340 nm) |
| 1 | UV | 60 | 8 | 0.88 |
| 2 | Condensation | 50 | 4 | 0 |

All films were applied to sealed Leneta Penopac Charts, Form WB, using a 3 mil Bird Film Applicator®. The charts were held in place with a vacuum plate to ensure a uniform film thickness. The films were dried at ambient temperature for 24 hours and then tested.

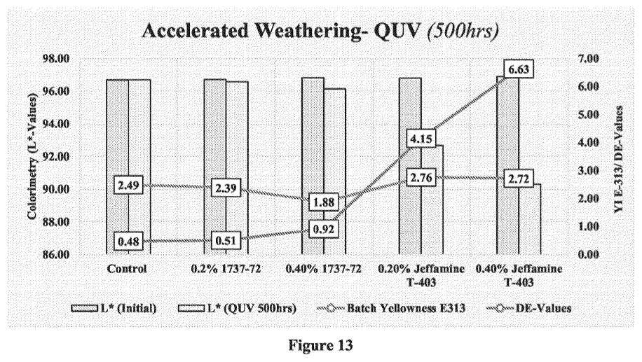

FIG. 13 exhibits color analysis of samples exposed to a QUV accelerated weathering chamber for 500 hours at Cycles UV: 8 hours at 60° C. Condensation: 4 hours at 50° C. Control (U210533-01) did not exhibited changes compromising dry film properties after weathering exposure. 0.20% “1737-72” (U210533-02) and 0.40% “1737-72” (U210533-03) displayed a minimal alteration of L* values and low DE values of 0.51-0.92 units between the two trials. In addition yellowness index results exhibited no notable contribution to yellowing of the dry films since Control (U210533-01) yellowed at a similar rate. However, 0.20% Jeffamine T-403 (U210533-04) and 0.40% Jeffamine T-403 (U210533-05) showed greater degradation (FIG. 4) in L* Values as color deteriorated due to weathering exposure. By utilizing higher use levels of Jeffamine T-403 coating properties degenerated and L* values dropped. It was noted that the Yellowness Index displayed slightly higher values. Overall, 0.20% “1737-72” (U210533-02) and 0.40% “1737-72” (U210533-03) withstand weathering conditions better than samples containing Jeffamine T-403.

### Example 13

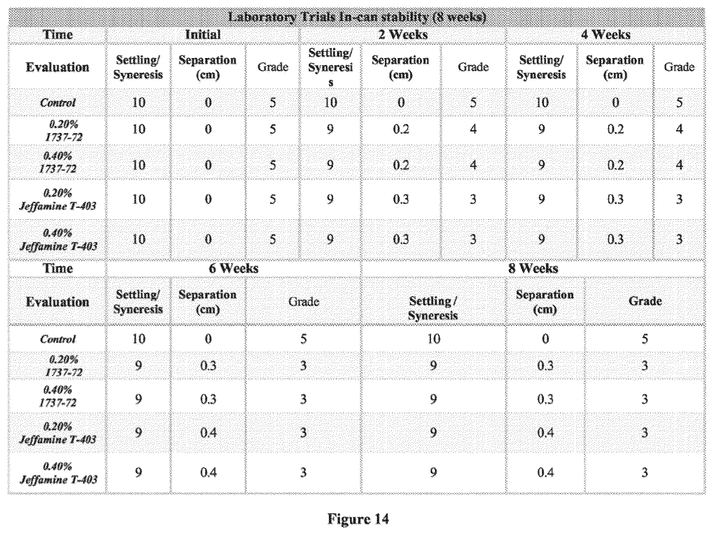

FIG. 14 displays the in-can stability ratings of the test coatings for a period of 8 weeks of heat aging. The samples were evaluated for separation and settling in accordance with ASTM D869, Standard Test Method for EvaluatingDegree of Settling of Paints. Samples were rated for degree of settling on a scale of 0 to 10, with 0 being complete separation/hard settling and 10 being no separation or settling.

### Rating Description of Sample Condition

| Rating | Description |
|---|---|
| 10 | Perfect suspension. No change from the original |
| | condition of the paint. |
| 8 | A definite feel of settling and a slight deposit brought |
| | up on spatula. No significant resistance to sidewise |
| | movement of spatula. |
| 6 | Definite cake of settled pigment. Spatula drops through |
| | cake to bottom of container under its own weight. |
| | Definite resistance to sidewise motion of spatula. |
| 4 | Spatula does not fall to bottom of container under its own |
| | weight. Difficult to move spatula through cake sidewise |
| | and slight edgewise resistance. Sample can be remixed |
| | readily to a homogeneous state. |
| 2 | When spatula has been forced through the settled layer it is |
| | very difficult to move spatula sidewise. Definite edgewise |
| | resistance to movement of spatula. Sample can be remixed |
| | to a homogeneous state. |

The test paints were stored under accelerated aging conditions at a temperature of 50° C. for a total of 8 weeks. The laboratory trials were observed for signs of Syneresis after each storage interval. The test samples were rated in accordance to ASTM D1849 and Spektrochem rating for classifications of Syneresis.

### Rating Classification of Syneresis

| Rating | Description |
|---|---|
| 5 | No presence of syneresis in the can. |
| 4 | The water layer is invisible when the can is standing. After |
| | tilting, a minimal water film collects at the edge of the can. |
| 3 | The water layer is barely visible when the can is standing. |
| | When tilted, a clearly visible water film forms at |
| | the edge of the can. |
| 2 | The water layer is clearly visible without tilting the can; |
| | however, its thickness is not very significant. |
| 1 | Very thick water layer on the can. |

No settling was found in the samples; however, signs of Syneresis were present in samples containing “1737-72” and Jeffamine T-403 at both use levels. Syneresis is the release of a small amount of fluid on the surface of the coatings in the container and was evaluated based on two test methods in order to provide accurate evidence of the behavior. In addition, exactly when the Syneresis occurred in the coating was determined. Signs of syneresis were observed at the 2-week mark during accelerated aging. Even though Syneresis at the surface was present, no pigment settling was observed, and once the coatings were mixed with a spatula homogeneity was easily achieved. The Syneresis did not cause adverse effects on film properties, and no film defects were observed.

Overall, “1737-72” and Jeffamine® T-403 were incorporated into a no VOC, acrylic, semi-gloss, architectural coating formulation at 0.2% and 0.4% by weight in the grind phase of production. Effects on coating performance and stability were evaluated in all phases of the manufacturing process as well as dry film and stability properties. The data generally show that while 0.2-0.4% w/w Jeffamine® T-403 can have positive and negative effects on paint properties, the blended multifunctional booster product “1737-72” significantly and surprisingly minimizes the majority of observed negative impacts of Jeffamine® T-403 on paint properties, even when compared on equal active polyetheramine content, while also improving its ability to act as an in-container booster.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A multifunctional booster composition, comprising:
at least one compound of the Formula I, 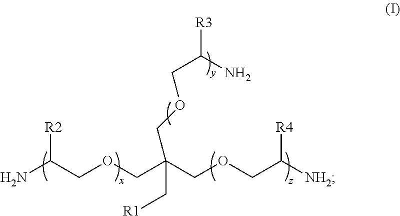
and
at least one additive comprising an inorganic metal compound, a silicate, a pyrithione salt, or an organic amine,
wherein R1 is H or C₁ to Co alkyl, each of R2, R3, and R4 is independently H or CH₃, and each of x, y, and z is independently 1 to 10, and
wherein a weight ratio of the compound of Formula I to the additive is 1:5 to 100:1.

2. The composition of claim 1, wherein the sum of x, y, and z is no less than 5.

3. The composition according to claim 1, wherein the sum of x, y, and z is no greater than 10.

4. The composition of claim 1, wherein the compound of the Formula I is present in the composition at a concentration of from about 20% by weight to about 80% by weight.

5. The composition of claim 1, wherein the inorganic metal compound comprises one or both of an inorganic zinc compound, an inorganic magnesium compound, an inorganic copper compound, or an inorganic lithium compound.

6. The composition according to claim 5, wherein the inorganic zinc compound comprises one or more of zinc oxide, zinc nitrate, zinc chloride, and zinc acetate.

7. The composition according to claim 5, wherein the inorganic magnesium compound comprises magnesium oxide.

8. (canceled)

9. (canceled)

10. The composition of claim 1, wherein the silicate comprises one or both of potassium methyl siliconate and sodium metasilicate.

11. The composition of claim 1, wherein the pyrithione salt comprises one or both of zinc pyrithione and sodium pyrithione.

12. The composition of claim 1, wherein the organic amine comprises a pH adjusting agent.

13. (canceled)

14. A water-based industrial material, comprising:
a multifunctional booster of at least one compound of the Formula I, 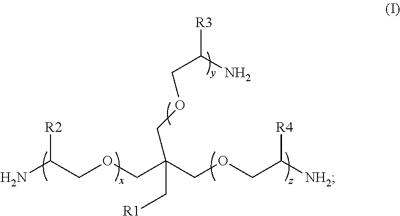
and
at least one additive comprising an inorganic metal compound, a silicate, a pyrithione salt, or an organic amine,
wherein R1 is H or C₁ to Co alkyl, each of R2, R3, and R4 is independently H or CH₃, and each of x, y, and z is independently 1 to 10,
wherein a weight ratio of the compound of Formula I to the additive is 1:5 to 100:1, and
wherein the water-based industrial material is a nonreactive water-based industrial material.

15. The water-based industrial material of claim 14, wherein the industrial material is selected from the group consisting of paints, coatings, plasters, adhesives, sealants, caulks, mineral slurries, pigment dispersions, pigment slurries, concrete, polymer emulsions, polymer dispersions, inks, sizes, agricultural pesticide formulations, household cleaning products, personal care products, varnishes, sealing compositions, leather auxiliaries, paper coating agents, cosmetics, shampoos, bodywashes, conditioners, and preservatives for such industrial materials.

16. The water-based industrial material of claim 14, wherein the at least one compound of the Formula I is present in the composition from about 20% to about 80% by weight of the composition.

17. The water-based industrial material according to claim 14, wherein the inorganic metal compound is present in the composition at a concentration of from about 0.2% to about 20% by weight of the composition.

18. The water-based industrial material according to claim 14, wherein the inorganic metal compound comprises one or both of an inorganic zinc compound, an inorganic magnesium compound, an inorganic copper compound, or an inorganic lithium compound.

19. The water-based industrial material of claim 18, wherein the inorganic zinc compound comprises one or more of zinc oxide, zinc nitrate, zinc chloride, and zinc acetate.

20. The water-based industrial material of claim 18, wherein the inorganic magnesium compound comprises magnesium oxide.

21. (canceled)

22. (canceled)

23. The water-based industrial material of claim 14, wherein the silicate is present in the composition at a concentration of from about 0.5% to about 15% by weight of the composition.

24. The water-based industrial material of claim 14, wherein the silicate comprises one or both of potassium methyl siliconate and sodium metasilicate.

25. The water-based industrial material of claim 14, wherein the pyrithione salt is present at a concentration of from about 5 ppm to about 500 ppm.

26. The water-based industrial material of claim 14, wherein the pyrithione salt comprises one or both of zinc pyrithione and sodium pyrithione.

27. The water-based industrial material of claim 14, wherein the organic amine comprises a pH adjusting agent.

28. (canceled)

29. A method for enhancing in-container preservative performance of a water-based industrial material, comprising adding to a water-based industrial material an effective amount of the multifunctional booster according to claim 1.

30. (canceled)

31. (canceled)
